(19) United States
(12) Patent Application Publication
(10) Pub. No.: US 2015/0332043 A1
(43) Pub. Date: Nov. 19, 2015

(54) APPLICATION ANALYSIS SYSTEM FOR ELECTRONIC DEVICES

(71) Applicant: Auckland UniServices Limited, Auckland (NZ)

(72) Inventor: Giovanni Russello, Auckland (NZ)

(21) Appl. No.: 14/693,038

(22) Filed: Apr. 22, 2015

(30) Foreign Application Priority Data
May 15, 2014 (AU) 2014901802

(51) Int. Cl. G06F 21/52; G06F 21/56

(52) U.S. Cl. CPC G06F 21/52; G06F 21/566; G06F 21/567; G06F 2221/033

(57) ABSTRACT

An analysis system for analysing applications executing on a target device. The system comprises an analysis agent operating on the target device that is configured to receive or retrieve information indicative of system call invocations initiated by applications during execution. The system also comprises an analysis device in data communication with the target device over a data communication link that is configured to receive the information from the analysis agent of the target device over the data communication link. The analysis device comprises an analysis graphical user interface (GUI) that is configured to display the received information for viewing and/or interaction by a user.

### CROSS-REFERENCE TO RELATED APPLICATION(S)

The present application claims the benefit of priority under 35 U.S.C. §119 to Australian Patent Application No. 2014901802, filed May 15, 2014, which is incorporated herein by reference in its entirety.

### FIELD OF THE INVENTION

This specification relates to a system for analysing and profiling applications executing on electronic device operating systems including, but not limited to, Linux or Linux-based systems. In particular, although not exclusively, the analysis system is suited for hardware devices and systems such as mobile phones, smartphones, tablet computers and other portable and desktop computing and communication devices.

### BACKGROUND TO THE INVENTION

The ANDROID™ operating system (Android), available from Google Inc. of Mountain View, Calif., is a Linux-based operating system designed primarily for touchscreen mobile devices such as smartphones and tablet computers. Android uses a Linux kernel at its core, and also provides an application framework that software developers can use to implement Android applications and services. Android additionally provides a native middleware layer between the Linux kernel interface and the Android applications and services that execute at the higher application layer to enable easier cross-platform development for deploying the same applications or services across different types of hardware devices.

This middleware layer includes a set of shared libraries that provide services such as data storage, screen display or multimedia, and are compiled to machine language to enable services to execute quickly. The middleware libraries implement device-specific functions, so applications and the application framework need not concern themselves with the variations between Android devices. The middleware layer also supports a specialized version of the Java runtime to simplify cross-platform development. In particular, it provides the Dalvik Virtual Machine (DVM) and its core Java application libraries. Applications or services implemented by developers can be compiled from Java (or other supported languages) to a byte-code that can be run by the DVM.

Although the middleware layer simplifies application development, it also adds significantly more complexity to the overall Android operating system. This additional complexity can be exploited by applications or services programmed to perform malicious tasks (malware) or execute malicious code (malcode).

By way of example, malware or malcode can exploit Inter-Process Communications (IPC) or Inter-Component Communications (ICC) to attack sensitive applications and their data. Referring to FIG. 1, each Android application 10, 12 is executed in a respective DVM 14, 16. When launched, each application corresponds to an instance of a DVM. Each DVM 14, 16 is mapped into a dedicated process 18, 20 running in User Mode 22 in the Linux layer 24. In Android, applications can communicate with each other using IPC mechanisms. The standard mechanism in Android to implement IPC is though the Binder framework. The Binder framework has the facility to provide bindings to functions and data from one process to another. The Binder framework in Android is provided in three levels. At the application layer 42 there is an Application Programming Interface (API) 26, 28 to enable applications to communicate with each other. The Android Interface Definition Language, which is part of this API, allows developers to define the interface for an Android service and an AIDL parser generates the Java client code that the service clients can use and a service stub that the developer can use to create the service implementation. At the native middleware layer 44 a Binder class 30, implemented using the C++ language, provides the user space facilities to be used by the applications via Java Native Interface (JNI) and interacts with the Binder kernel driver 32, which is part of the customized Linux Android kernel. The Binder kernel driver 32 carries out the message passing between processes and provides a shared memory facility. The driver sits behind a special device, /dev/binder, and can be used through various system calls, such as open and ioctl, to enable processes to communicate with each other.

As shown in FIG. 1, the IPC mechanism can be described in two layers. At the Android layer 46, when Application 1 (10) sends an IPC through its AIDL API (26) as shown at 34, the binder code 30 in the middleware will take care of the delivery of the request to the destination Application 2 (12) as shown at (36). At the Linux layer, this operation is translated into a sequence of system calls (open and ioctl) executed by Process 1 (18) (corresponding to Application 1) using the binder kernel driver (dev/binder) 32 as shown at (38). The request is then forwarded to Process 2 (20) (corresponding to Application 2) as shown at (40).

In conventional Unix and Linux operating systems, security systems such as SELinux or the Linux Security Modules have been proposed in the form of a kernel module that can trace a process to enforce security policies. This involves recompiling the kernel image in order to register the module and to be able to eventually load it. Additionally, as new applications are launched by the user via a shell command line, the monitoring module is able to link the correct security policy to the newly launched process by analyzing the command line arguments. Such security systems do not work effectively on Android, which uses a distinctly different way of launching and managing Applications. It is also desirable to have a security system for Android that does not require recompilation of the Linux kernel.

Administrators setting security policies for security systems deployed on devices may need to analyse or profile applications executing in runtime to identify malicious or suspicious behavior. Some devices running operating systems such as Linux require specialized kernel level modules, such as the Audit system, to support such analysis. However, the kernel present in Android, while a Linux-based kernel, is often a stripped down version of the desktop computer version, and the kernel modules such as Audit are not present by default.

Debuggers can be used by administrators to analyse applications. However, debuggers rely on libraries to be compiled with special flags enabled to be able to collect meaningful information. The libraries employed on devices by default have the debug symbols disabled for performance reasons. To enable the debug symbols the user has to recompile the libraries with compilation special flags and redeploy them in the device.

In this specification where reference has been made to patent specifications, other external documents, or other sources of information, this is generally for the purpose of providing a context for discussing the features of the various embodiments. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

It is an object of at least some embodiments to provide a system for analysing and/or profiling an application executing on an operating system of a device, or to at least provide the public with a useful choice.

It is an object of at least some embodiments to provide a system for analysing the performance of a security policy or policies being enforced by a security system against an application executing on an operating system of a device, or to at least provide the public with a useful choice.

In a first aspect, the present invention broadly consists in an analysis system for analysing applications executing on a target device, the system comprising:
an analysis agent operating on the target device that is configured to receive or retrieve information indicative of system call invocations initiated by applications during execution; and
an analysis device in data communication with the target device over a data communication link that is configured to receive the information from the analysis agent of the target device over the data communication link, and wherein the analysis device comprises an analysis graphical user interface (GUI) that is configured to display the received information for viewing and/or interaction by a user.

In an embodiment, the target device further comprises a monitoring entity associated with each executing application, each monitoring entity being configured to detect, directly or indirectly, system call invocations made by its associated application. In one form, the monitoring entities directly monitor or detect system call invocations by intercepting the system call invocations to the kernel of an operating system of the target device. In another form, the monitoring entities indirectly monitor or detect system call invocations by intercepting shared or dynamic library symbol invocations that are intended to invoke one or more system calls to the kernel.

In an embodiment, the monitoring entities forward, directly or indirectly, the detected system call invocations to the analysis agent. In one embodiment, each monitoring entity comprises an associated profiler that is configured to retrieve or receive information indicative of the system call invocations detected by its associated monitoring entity, and forwarding that information to the analysis agent.

In some embodiments, the profilers are configured to send information to the analysis agent over an Inter Process Communication (IPC) channel.

In an embodiment, the monitoring entities are configured to stall or pause execution of the application on detection of a system call invocation, and awaits a security decision for enforcement, the security decision being an instruction on how to handle the execution of the detected system call invocation. By way of example, in one embodiment, the security decision may be any one of the following: allow the system call to execute, deny the system call from executing, modifying the system call, or killing the application execution altogether.

In some embodiments, the analysis system is operable in a selected one of a plurality of modes. In some configurations, the selected mode determines how the monitoring entities are configured to determine a security decision for enforcement for each detected system call invocation.

In one operational mode of the analysis system (e.g. single-step mode), the monitoring entities are configured to forward information indicative of detected system call invocations to the analysis agent, via their respective profilers, and await a security decision from the analysis agent for enforcement. The analysis agent forwards the information indicative of the detected system call invocation(s) to the analysis device and a security decision is generated for the analysis agent based on user input into the analysis GUI. The generated security decision is sent to the analysis agent, which then forwards it to the monitoring entity, via its respective profiler, for enforcement. For example, the security decision how to handle the system call invocation is decided by the user, and the generated security decision is forwarded to the analysis agent. In one form, the or each security decision generated by the user during analysis of a target device is stored in a security policy file or files to generate a customized security policy or policies for the target device. In some embodiments, these stored security policy file or files can be deployed for future enforcement by a security system operating on the target device or a set of similar target devices, for example for a particular user group.

In some embodiments, the monitoring entities may be components of a security system in which the monitoring entities enforce security decisions in response to detected system call invocations based on a security policy or policies accessible by the security system. In another operational mode of the analysis system (e.g. logging or policy-debugging mode), the monitoring entities are configured to retrieve and enforce the security decision for a detected system call invocation based on the security policy or policies of the security system, and then forward information indicative of the detected system call invocation and enforced security decision to the analysis agent via their respective profilers. The information is then sent by the analysis agent to the analysis device for analysis by a user via the analysis GUI.

In one embodiment, the data communication link between the target device and analysis device may be wired, such as, but not limited to, a USB cable connection. In another embodiment, the data communication link may be wireless, such as, but not limited to, a WiFi or Bluetooth.

In some configurations, the analysis agent is configured to store information received from the profilers in a buffer prior to sending it to the analysis device.

In some configurations, the analysis agent is configured to commence receiving or retrieving information indicative of system call invocations made by applications executing on the target device in response to receiving a start instruction from the analysis device over the data communication link. In one form, the start instruction may further comprises the mode of operation the analysis agent should adopt.

In one form, the analysis agent stores the received information in a buffer, and then streams or sends the buffered information to the analysis device upon receiving a request instruction from the analysis device over the data communication link. In this configuration, the analysis device pulls the information from the analysis agent.

In some configurations, the analysis agent is configured to cease receiving or retrieving information indicative of the system call invocations in response to receiving a stop instruction from the analysis device over the data communication link.

In one embodiment, the target device is a smartphone, tablet, or any other programmable device with an operating system capable of executing applications, and the analyser device is any programmable device with an associated display for the analysis GUI and user input device(s), such as touch screen, mouse, keyboard, and/or similar.

In some embodiments, the target device comprises a Linux-based kernel, and a system architecture defined by a Linux layer associated with the kernel and the higher application layer comprising applications. In other embodiments, the target device comprises architecture comprising a kernel space and user space, wherein the kernel space comprises a Unix-like kernel and the user space comprises the applications.

In some configurations the operating system is Andriod, iOS, Windows, or any other suitable operating system.

In a second aspect, the invention broadly consists in a method of analysing applications executing on a target device via an analysis graphical user interface (GUI) displayed on an analysis device in data communication with the target device over a data communication link, comprising:
sending a request instruction over the data communication link to an analysis agent of the target device to request information indicative of the system call invocations initiated by the applications during execution;
receiving at the analysis device the requested information from the analysis agent over the data communication link; and
displaying the requested information to a user on the analysis GUI.

In one configuration, the method further comprises generating a start instruction over for the analysis agent on the target device to initiate the analysis agent to receive or retrieve information indicative of detected system call invocations initiated by applications during execution. In one form, the start instruction may be a command generated and sent to the analysis agent over the data communication link. In another form, the start instruction may be generated in response to a successful data communication link or connection between the target device and analysis device being established.

In an embodiment, the method further comprises generating a security decision for a detected system call invocation in response to user input, and sending the generated security decision to the analysis agent on the target device over data communication link for enforcing against the detected system call invocation. In such embodiments, the method may further comprise storing each generated security decision in a security policy file or files to generate a customized security policy or policies for the target device.

In another embodiment, the method further comprises requesting information indicative of the security decisions enforced by a security system operating on the target device in response to detected system call invocations.

In a third aspect, the invention broadly consists in a method of analysing applications executing on a target device for an analysis graphical user interface (GUI) displayed on an analysis device in data communication with the target device over a data communication link, comprising:
receiving or retrieving at the target device, directly or indirectly, information indicative of detected system call invocations initiated by applications during execution from monitoring entities associated with each executing application;
receiving at the target device a request instruction over the data communication link from the analysis device for the information indicative of the system call invocations initiated by the applications during execution; and
sending the requested information to the analysis device over the data communication link.

In some embodiments, the method further comprises receiving or retrieving information indicative of system call invocations initiated by applications during execution in response to receiving a start instruction. In one form, the start instruction may be a command received from the analysis device over the data communication link. In another form, the start instruction may be generated in response to a successful data communication link or connection between the target device and analysis device being established.

In an embodiment, the method further comprises halting operation of an application on detection of a system call invocation and awaiting a security decision on how to handle the execution of the detected system call invocation. In one form, the method comprises receiving the security decision from the analysis device over the data communication link. In another form, the method comprises generating the security decision based on a security policy or policies linked to the application. In such embodiments, the method further comprises sending the received or generated security decision to the monitoring entity associated with the application to which the security decision relates for enforcement.

In some embodiments, the method further comprises sending information indicative of the generated security decisions for detected system call invocations to the analysis device over the data communication link together with the information indicative of the detected system call invocations.

In a fourth aspect, the invention broadly consists in a computer-readable medium having stored thereon computer readable instructions that, when executed on a processing device, cause the processing device to perform any one or more of the methods defined in the previous aspects.

In a fifth aspect, the invention broadly consists in a system or device having a processor or processors configured or programmed to carry out or execute any one or more of the methods defined in the previous aspects.

Other Aspects

Any one or more of the following aspects and/or features of the security system may apply to the first-third aspects of the invention.

In one aspect, some embodiments comprise a security system for an operating system running on a device, the operating system architecture comprising a lower layer comprising a kernel operable in a kernel mode and a user mode within which processes execute corresponding to an application in a higher application layer, and a middleware layer between the lower layer associated with the kernel and the higher application layer comprising applications, the system comprising:
a main monitor process running in the user mode of the lower layer which is configured to detect the launch of a new process in the user mode of the lower layer by a mother process, the new process corresponding to the launching of a new application or part of an application in the application layer by the user of the device;
a process monitor attached by the main monitor to each new process created by the mother process and each process monitor also executing in the user mode of the lower layer and being configured to monitor the system calls made by its attached process to the kernel; and
a security system service running at the application layer that is operable to access stored configurable security policies for the applications of the application layer, and which communicates with each process monitor in the lower layer the security policies corresponding to its attached process, and wherein each process monitor is configured to retrieve and enforce the security policy configured for its attached process based on the parameters of the detected system calls.

In another aspect, some embodiments comprise a security system for an operating system running (e.g., executing) on a device that comprises a Linux-based kernel, and a system architecture defined by a Linux layer associated with the kernel and the higher application layer comprising applications, the system comprising:
a main monitor process running at the Linux layer which is configured to detect the launch of a new process in the Linux layer by a mother process, the new process corresponding to the launching of a new application or part of an application in the application layer by the user of the device;
a process monitor attached by the main monitor process to each new process created by the mother process and each process monitor being configured to monitor the system calls made by its attached process to the kernel; and
a security system service running at the application layer that is operable to access stored configurable security policies for the applications of the application layer, and which communicates with each process monitor in the Linux layer the security policies corresponding to its attached process, and wherein each process monitor is configured to retrieve and enforce the security policy configured for its attached process based on the parameters of the detected system calls.

In some embodiments, the monitor process is configured to enforce the retrieved security policy for its target process by implementing a security action at the Linux layer in regard to the detected system call based on the retrieved security policy. The security action may comprise any one or more of the following: allowing the system call to proceed, blocking the system call from proceeding, modifying parameters of the system call prior to execution or return values generated by the system call after execution, or prompting the user of the device to select a security action. By way of example, the monitor process may implement a security action by instructing and controlling the kernel in regard to its execution of the requested system call by the attached monitored process.

Each process monitor may be configured to enforce security policies based on parameters extracted from the detected system calls. For explicit system calls, the security policies may be evaluated and enforced based directly on extracted system call parameters. For implicit system calls, the process monitors may be configured to retrieve further information about the system call from the security system service in the application layer before evaluating and enforcing the security policies.

In another aspect, some embodiments comprise a security system for an operating system running (e.g., executing) on a device that comprises a Linux-based kernel, and a system architecture defined by a Linux layer associated with the kernel and the higher application layer comprising applications, the system comprising:
a main monitor process running at the Linux layer which is configured to detect the launch of a new process in the Linux layer by a mother process, the new process corresponding to the launching of a new application or part of an application in the application layer by the user of the device;
a process monitor attached by the main monitor process to each new process created by the mother process and each process monitor being configured to monitor the system calls made by its attached process to the kernel; and
a security system service running at the application layer that is operable to access stored configurable security policies for the applications of the application layer, and which communicates with each process monitor in the Linux layer the security policies corresponding to its attached process, and wherein each process monitor is configured to retrieve and enforce the security policy configured for its attached process based on the parameters of the detected system calls.

In one embodiment, the system architecture is further defined by a middleware layer between the Linux layer and higher application layer.

The security system may further comprise an accessible policy database comprising stored configurable security policies for the applications in the application layer. The policy database may be stored on the device or remotely stored and accessible to the device.

In some embodiments, the operating system is Android. In some such embodiments, the mother process is the Zygote process.

The main monitor process is typically attached to the mother process. The attachment may be created by a process trace system call, with the main monitor configured as the master process and the mother process being configured as the target process.

Each process monitor may be attached to its respective process by a process trace system call, with the process monitor being the master process and its respective attached process being the target process.

Each process monitor may be configured to load the security policies for its attached target process by retrieving the security policies from the security system service. Each process monitor may be configured to monitor the specialization process of its target process to extract application identification data indicative of the application the target process is specializing as, and to retrieve the relevant security policies for the target process from the security system service based on the extracted application identification data.

In some embodiments, the process monitor(s) communicate with the security system service over a communication link or mechanism between the Linux layer and application layer. By way of example, the communication mechanism may be client-server transactions over a TCP link or similar.

In another aspect, some embodiments comprise a method of securing an operating system running on a device comprising a Linux-based kernel in a Linux layer, the system architecture comprising an application comprising applications in an application layer above the Linux layer, the method comprising:
embedding a monitoring entity within each newly launched process in the Linux layer corresponding to a new application or an application component in the application layer;
configuring each newly launched process to redirect at least some of its shared or dynamic library symbol invocations to the embedded monitoring entity within the process;
configuring each embedded monitoring entity to analyze redirected symbol invocations made by its associated process and perform a security action based on a security policy associated with the process.

In some embodiments, the shared or dynamic library symbol invocations correspond to or represent function invocations or function calls in a shared or dynamic library that are intended to invoke one or more system calls in the kernel mode.

In one embodiment, the method comprises redirecting all symbol invocations made by a process to the embedded monitoring entity within the process. In another embodiment, the method comprises redirecting a predefined or predetermined set of symbol invocations made by a process to the embedded monitoring entity within the process.

In some embodiments, the security action may comprise any one or more of the following:
denying execution of the function call represented by the symbol in the shared or dynamic library to prevent its execution and the execution of any system call(s) it may use,
allowing execution of the function call represented by the symbol by sending the function call to the intended shared or dynamic library for execution to allow invocation of it and of any system call(s) it may use, or
modifying the symbol invocation by sending a modified function call to the intended shared or dynamic library for execution to allow invocation of a modified system call in the kernel.

Embedding a monitoring entity within each newly launched process may comprise embedding a process monitor method or function within the process.

Configuring each newly launched process to redirect shared or dynamic library symbol invocations to the embedded monitoring entity may comprise configuring a Function Call Interposition (FCI) mechanism for each newly launched process. By way of example, the FCI mechanism is configured to intercept and redirect symbol invocations to the embedded process monitor with the process.

In one form, the FCI mechanism comprises configuring or providing a set of proxy functions (proxy function library) in each new process that intercept the symbol invocations and redirect them to the embedded monitoring entity within each process. The proxy function library in some such embodiments, is configured to intercept symbol invocations intended for shared or dynamic libraries.

In a first form, configuring an FCI mechanism for each process comprises configuring the runtime linker to link the process to the proxy function library before any other shared or dynamic libraries. By way of example, the method may comprise configuring the LD_PRELOAD environment variable to instruct the runtime linker to link to the proxy function library when a process is launched.

In a second form, configuring an FCI mechanism for each process comprises modifying the process image to redirect dynamically linked symbol invocations to the proxy function library of the process. In some embodiments, this step comprises modifying the address entries of the symbols in the Global Offset Table (GOT) of the process to point to an entry in the proxy function library of the process, and where the GOT is part of the Executable and Linkable Format (ELF) of the process. By way of example, the proxy function library may be in the form of a Proxy Offset Table (POT), and each entry in the POT may be configured to point to the embedded monitoring entity of the process.

In a third form, configuring an FCI mechanism for each process may comprise:
configuring the runtime linker to link any mother process to the proxy function library before any other shared object libraries; and
modifying the process image in memory of any new processes launched by the mother process to redirect shared or dynamic library symbol invocations to the proxy function library of the process.

By way of example, the operating system may be Android, and the mother process the Zygote process.

In another aspect, some embodiments comprise a method of securing an operating system running on a device comprising a Linux-based kernel in a Linux layer, the system architecture comprising applications in an application layer above the Linux layer, the method comprising:
intercepting shared or dynamic library symbol invocations made by processes that are intended to invoke system calls in the kernel;
initiating a security action for intercepted symbol invocations based on a security policy configured for the application corresponding to the process calling the intercepted symbol invocation.

In another aspect, some embodiments comprise a security system for an operating system running on a device that comprises a Linux-based kernel, and a system architecture defined by a Linux layer associated with the kernel and the higher application layer comprising applications, the system comprising:
an embedded monitoring entity within each launched process in the Linux layer, each launched process corresponding to an application in the application layer;
an interceptor associated with each process that is configured to intercept at least some of the shared or dynamic library symbol invocations made by its associated process and redirect them to the embedded monitoring entity within the process initiating the symbol invocations, and
wherein the embedded monitoring entities are configured to analyze the intercepted symbol invocations made by their associated processes and perform a security action based on a security policy associated with the process.

In another aspect, some embodiments comprise a method for securing an operating system running on a device comprising a Linux-based kernel and a system architecture defined by a Linux layer associated with the kernel and the higher application layer comprising applications, the method comprising:
creating a monitoring entity which monitors system and/or library function calls invoked by a mother process to detect the creation of a new process which will correspond to a new application in the application layer; and
creating a new monitoring entity to monitor to the newly launched process once it is created by the mother process, the new monitoring entity being configured to detect system and/or library function calls made by the new process and to retrieve and enforce security policies configured for the new process based on the parameters of the detected system and/or library function calls.

In one embodiment, the system architecture is further defined by a middleware layer between the Linux layer and higher application layer.

In one form, the monitoring entity is defined as a Linux process. For example, the monitoring entity may be a separate monitor process linked or attached to the target process it is monitoring. In another form, the monitoring entity may be an embedded process monitor method or function within the target process being monitored.

The application may be an application program or an application component such as, but not limited to Activities, Services, Content Providers or Broadcast receivers.

In another aspect, some embodiments comprise a method for securing an operating system running on a device comprising a Linux-based kernel and a system architecture defined by a Linux layer associated with the kernel and the higher application layer comprising applications, the method comprising:
creating a monitoring entity which monitors, directly or indirectly, system calls invoked by a mother process to detect the creation of a new process which will correspond to a new application in the application layer; and
creating a new monitoring entity to monitor to the newly launched process once it is created by the mother process, the new monitoring entity being configured to detect, directly or indirectly, system call invocations made by the new process and to retrieve and enforce security policies configured for the new process based on the parameters of the detected system call invocation.

In one embodiment, the system architecture is further defined by a middleware layer between the Linux layer and higher application layer.

In one form, the monitoring entities directly monitor or detect system call invocations by intercepting the system call invocations to the kernel. In another form, the monitoring entities indirectly monitor or detect system call invocations by intercepting shared or dynamic library symbol invocations that are intended to invoke one or more system calls to the kernel.

In some configurations, the monitor may comprise: a monitoring entity which monitors, directly or indirectly, system calls invoked by a mother process to detect the creation of a new process which will correspond to a new application, and wherein the monitor is configured to create a new monitoring entity to monitor the newly launched process once it is created by the mother process, the new monitoring entity being configured to detect, directly or indirectly, system call invocations made by the new process and to enforce policies linked or associated with the new process based on the parameters of the detected system call invocation. In one such configuration, the monitoring entities may directly monitor or detect system call invocations by intercepting the system call invocations to the kernel. In another such configuration, the monitoring entities may indirectly monitor or detect system call invocations by intercepting shared or dynamic library symbol invocations that are intended to invoke one or more system calls to the kernel.

The monitor code may be configured to monitor interaction of a process with the kernel by monitoring shared or dynamic library symbol invocations and/or system calls and the policy file or files may define actions in response to given symbol invocations or system calls made by the process linked to the policy file or files. The actions may include one or more of: blocking the symbol invocation or system call, redirection of symbol invocations to an alternative library address, logging the symbol invocation or system call, killing the process, and suspending the symbol invocation or system call to allow authorization of the symbol invocation or system call by an operator.

In some configurations, the monitor may comprise: a monitoring entity which monitors, directly or indirectly, system calls invoked by a mother process to detect the creation of a new process which will correspond to a new application, and wherein the monitor is configured to create a new monitoring entity to monitor the newly launched process once it is created by the mother process, the new monitoring entity being configured to detect, directly or indirectly, system call invocations made by the new process and to enforce policies linked or associated with the new process based on the parameters of the detected system call invocation. In one form, the monitoring entities may directly monitor or detect system call invocations by intercepting the system call invocations to the kernel. In another form, the monitoring entities may indirectly monitor or detect system call invocations by intercepting shared or dynamic library symbol invocations that are intended to invoke one or more system calls to the kernel.

In another aspect, some embodiments comprise a device comprising one or more resources including a processor and configurable to functionalities defined in functional code received by the device, the device also comprising an operating system including a user layer operable to run processes and a kernel operable to provide interfaces for the processes to use one or more resources of the device, wherein the device stores launcher code operable to launch received functional code as a new process and to cause the new process to specialize dependent on the functional code whereby functionality defined for the device by functional code is executed with the new process using resources of the device via interfaces provided by the kernel, wherein the device also stores policy code defining a policy for each functional code or type of functional code received, and wherein the device comprises monitor code which is operable to associate instances of policy code with processes and to monitor processes dependent on associated policy code.

In one configuration, the monitor code may be further configured to enforce the policy or policies defined in the policy file or files linked or associated with the process.

In one configuration, the monitor code may be configured to monitor interaction of a process with the kernel by monitoring shared or dynamic library symbol invocations and/or system calls and the policy file or files define actions in response to given symbol invocations or system calls made by the process linked to the policy file or files. In one form, the actions may comprise any one or more of: blocking the symbol invocation or system call, redirection of symbol invocations to an alternative library address, logging the symbol invocation or system call, killing the process, and/or suspending the symbol invocation or system call to allow authorization of the symbol invocation or system call by an operator.

In one configuration, the monitor code may comprise: a monitoring entity which monitors, directly or indirectly, system calls invoked by a mother process to detect the creation of a new process which will correspond to a new application, and wherein the monitor code is configured to create a new monitoring entity to monitor the newly launched process once it is created by the mother process, the new monitoring entity being configured to detect, directly or indirectly, system call invocations made by the new process and to enforce policies linked or associated with the new process based on the parameters of the detected system call invocation. In one form, the monitoring entities directly monitor or detect system call invocations by intercepting the system call invocations to the kernel. In another form, the monitoring entities indirectly monitor or detect system call invocations by intercepting shared or dynamic library symbol invocations that are intended to invoke one or more system calls to the kernel.

In another aspect, some embodiments comprise a method of securing the operation of applications executed in a system comprising a linux layer and a middleware layer operable to launch applications by causing the processes in the linux layer to be spawned from other processes or from a mother process and to specialise with code specific to the application, the method comprising:
monitoring the mother process or existing process to detect a spawned process;
monitoring the spawned process execution in order to identify which process has specialized into; and
monitoring function calls made by the specialised process to determine a security action to enforce with respect to the function call.

In another aspect, some embodiments comprise a computer-readable medium having stored thereon computer readable instructions that, when executed on a processing device, cause the processing device to perform any one or more of the methods defined in the embodiments of the previous aspects.

In a another aspect, some embodiments comprise a system or device having a processor configured or programmed to carry out or execute any one or more of the methods defined in the embodiments of the previous aspects.

Definitions

The phrase “specialization process” or term “specializing” as used in this specification and claims is intended to mean, unless the context suggests otherwise, the process by which a newly created process, for example in the Linux layer of a Linux-based operating system, identifies the corresponding application in the application layer to which it relates and then retrieves and loads the application-specific code for that application for execution, or similar such processes in other Unix or Linux-based operating systems, including Android, iOS, Chromium, and Chromium OS.

The terms “attached” or “attaching” as used in this specification and claims is intended to mean, unless the context suggests otherwise, creating a relationship between two processes in the Linux layer whereby one process is configured to monitor and control the other process in parent-child or master-target relationship, and by way of example includes attachment by way of a process trace system call, e.g. ptrace, or any other mechanism that creates a link or attachment between processes which enables one process to control one or more aspects or functions of the other process.

The term “Linux” as used in this specification and claims is intended to mean, unless the context suggests otherwise, any Linux-based operating system employing a Linux, or Unix, or a Unix-like kernel.

The phrase “Linux layer” as used in this specification and claims is intended to mean, unless the context suggests otherwise, the layer in the operating system architecture for describing the operation of processes in User Mode (User Layer) and their interaction with the kernel in Kernel Mode (Kernel Layer).

The phrase “middleware layer” as used in this specification and claims is intended to mean, unless the context suggests otherwise, the layer in the operating system architecture for describing the software operating between the Linux layer and the application software in the application layer.

The phrase “application layer” as used in this specification and claims is intended to mean, unless the context suggests otherwise, the layer in the operating system architecture for describing the operation of user application software and services.

The phrase “mother process” as used in this specification and claims is intended to mean, unless the context suggests otherwise, typically the process running after boot-up of the operating system that controls the launch or initiation of all new children processes at the Linux layer via interaction with the kernel, and for example in the context of Android is equivalent to the Zygote process which initiates new processes by forking a new replica or image of itself, and for example in the context of Chromium or

Chromium OS is the equivalent of the main process running the browser which initiates new processes by forking or spawning a replica or image of itself, and may also be referred to as a “parent process”.

The terms “fork”, “forking”, “forked” as used in this specification and claims are intended to mean, unless the context suggests otherwise, the creation or spawning of a new process, and where typically in a Linux-based OS the new process is created or spawned by a mother process and starts as a replica or image of the mother process, but the terms are intended to refer to any other mechanism by which a new process is initiated or created.

The term “monitoring” as used in this specification and claims is intended to mean, in the context of a master-target process relationship, where the master intercepts, controls, modifies and/or traces system calls made by the target process to the kernel, and may also include or be referred to technically as “interposing” and/or “interleaving”.

The phrases “System Call Interposition (SCI)” and “SCI mechanism” or “SCI configuration”, as used in this specification and claims are intended to mean, unless the context suggests otherwise, the method of intercepting system calls initiated by a process by directly detecting and/or intercepting the system call made or invoked in the kernel mode of the Linux layer, including, by way of example but not limited to, the interaction between a shared object library and the system call gateway in the kernel, or direct system calls made to the system call gateway in the kernel from native code without using a shared object library, and where the SCI mechanism may be implemented by using ptrace for example or any other suitable interception mechanisms or systems.

The phrase “system call gateway” as used in this specification and claims is intended to mean, unless the context suggests otherwise, the entry point or an entry point in the kernel where system calls will or are executed.

The phrases “Function Call Interposition (FCI)” or “FCI mechanism” or “FCI configuration”, as used in this specification and claims are intended to mean, unless the context suggests otherwise, the method of detecting or intercepting shared or dynamic library symbol invocations initiated by a process, and where the symbol invocations represent function invocations or function calls from the process to a shared object library in the user mode of the Linux layer, and where the set of monitored symbol invocations are those which may be intended to invoke one or more system calls in the kernel mode of the Linux layer.

The phrases “function calls”, “symbol invocations”, “shared or dynamic library symbol invocations” or “shared object library function calls” as used in this specification and claims are intended to mean, unless the context suggests otherwise, function invocations made by a process to a shared or dynamic library that may be intended to invoke one or more system calls in the kernel mode.

The term “symbol” as used in this specification and claims is intended to mean, unless the context suggests otherwise, an entry in a table of a shared or dynamic library that corresponds to or represents a function.

The phrase “policy database” as used in this specification and claims is intended to mean, unless the context suggests otherwise, any electronic source or combination of sources, whether stored locally on the device or accessible remotely, which contains data indicative of the security policy or policies configured or defined for applications running on the device, and may be in the form of or comprise a policy configuration file comprising data defining one or more security policies, a set of policy configuration files each comprising data defining one or more security policies, or any electronic source or form of accessible electronic security policy.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The various embodiments comprise in the foregoing and also envisage constructions of which the following gives examples only.

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of device running an Operating System (OS) such as by way of example, but not limited to, Android OS, iOS, Chromium, Chromium OS, or any other Linux-based OS, and by way of example the device may be, but is not limited to, a desktop, laptop, notebook, tablet or mobile device. The phrase “mobile device” includes, but is not limited to, a wireless device, a mobile phone, a smartphone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

### BRIEF DESCRIPTION OF THE DRAWINGS

The various embodiments herein will be described by way of example only and with reference to the drawings, in which:

FIG. 1 is a schematic diagram of an Android operating system and showing an example of the IPC mechanism;

FIG. 2 is a schematic diagram showing the interdependency between shared library function call and system call mechanisms in the Linux layer.

FIG. 3 is a schematic diagram of the framework basic architecture for a security system in accordance with a first embodiment which is based on System Call Interposition (SCI);

FIG. 4 is a schematic diagram showing the Android operating system of FIG. 1 implementing the first embodiment security system;

FIG. 5 is a flow diagram of the system operations carried out by the first embodiment security system when creating a new process monitor for a newly launched application on an Android device;

FIG. 6 is a flow diagram of an example decision generation process in the first embodiment security system;

FIG. 7 is a schematic diagram of the Android operating system architecture and an example configuration of the first embodiment security system for controlling inter-process communication between application components in accordance with the configured security policies;

FIG. 8 is a schematic diagram of the framework basic architecture for a security system in accordance with a second embodiment which is based on Function Call Interposition (FCI);

FIG. 9A is a schematic diagram of the typical PLT/GOT indirection mechanism in the Android operating system;

FIG. 9B is a schematic diagram of the modified PLT/GOT indirection FCI mechanism in accordance with the second embodiment security system for intercepting dynamically linked symbol invocations;

FIG. 10 is a flow diagram showing the system operations carried out by the second embodiment security system when launching a new process with an embedded FCI mechanism;

FIG. 11 is a flow diagram of the system operations carried out by the second embodiment security system to dynamically switch to monitoring based on an SCI mechanism as carried out by the first embodiment security system;

FIG. 12 is a timeline of the launch of a new process corresponding to a new application, and a late security policy binding mechanism in accordance with an embodiment;

FIG. 13 is a schematic diagram of the hardware componentry of a typical smartphone or tablet device upon which the security system may run;

FIG. 14 is a schematic diagram of the typical storage device partitions in a device running an Operating System such as Android;

FIG. 15 is a schematic diagram of Chromium;

FIG. 16 is a schematic diagram of the security system applied to Chromium in a third embodiment;

FIG. 17 is a schematic diagram of an analysis system for analysing and/or profiling applications executing on a target device in accordance with an embodiment;

FIG. 18 is a schematic diagram of the data structures of an IPC call used in the data communication between profilers of the system to an analysis agent onboard the target device in the analysis system of FIG. 17 in accordance with an embodiment, and in particular a Process Data data structure, and System Call Info data structure of the Process Data data structure;

FIG. 19 is a schematic diagram of the Parameters data structure of the System Call Info data structure of FIG. 18 in accordance with an embodiment;

FIG. 20 is schematic diagram of the tree representation of a multi-level data structure enabled by the Parameters data structure of FIG. 19 in accordance with an embodiment; and

FIG. 21 is a schematic diagram of the Decision data structure utilized by the analysis system of FIG. 17 in accordance with an embodiment.

### DETAILED DESCRIPTION

### 1. Overview of Analysis System

The analysis system may be used in as a profiler tool for a security expert or administrator to analyse the execution of applications in runtime to identify malicious/suspicious behavior, configure suitable security policies for applying to applications by a security system, and/or analyse and refine the performace of existing security policies, e.g. for policy-debugging.

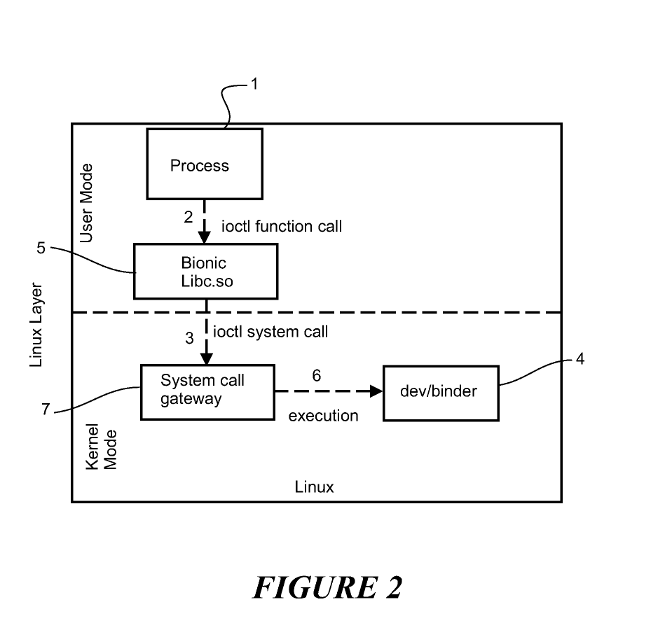

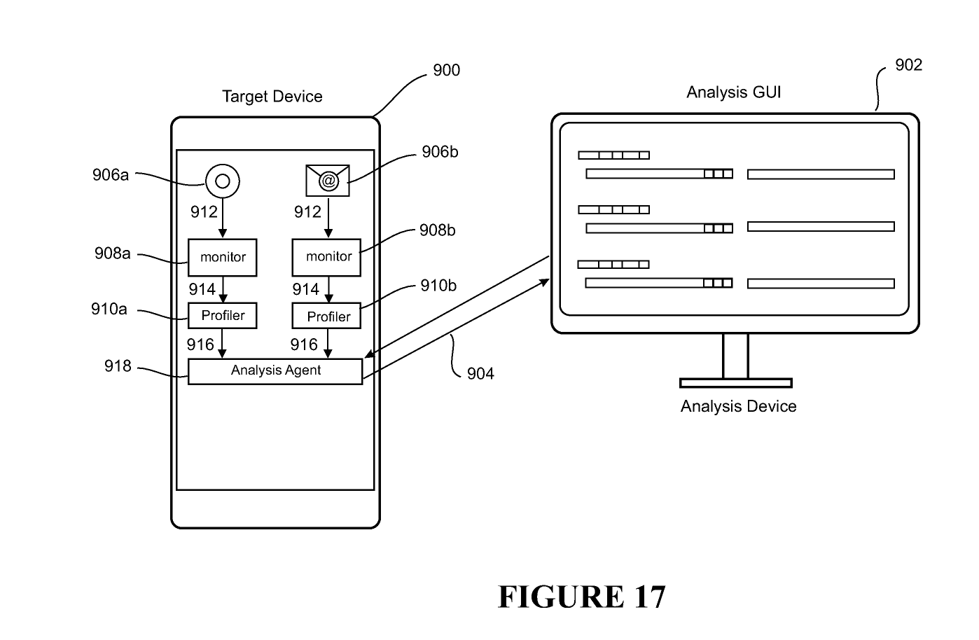

In an embodiment, the analysis system is an extension of a policy-based security system operating on the device. Embodiments of the security system will be described by way of example first with reference to FIGS. 2-16, followed by an embodiment of the analysis system with reference to FIGS. 17-21.

### 2. Overview of Security System

In conventional Unix and Linux operating systems, security systems have been proposed to mitigate malware IPC attacks between application programs by intercepting system calls to the kernel. System calls are a key mechanism that need to be monitored because they can be used to access sensitive parts of the operating system that are controlled by the kernel, for example the file system, shared memory, network connections and the like. For setting security policies it is often necessary to know which application has invoked a specific system call. In the Android OS, an application may include one or multiple processes. In turn, each process may run one or multiple threads concurrently to execute instructions, some of which may be trigger system calls that interact with the kernel. In conventional Unix and Linux systems the name of a process is known to the kernel as the binaries are launched by the user via a shell. The security system monitors all system calls and based on the relevant policy specified for a process they are either allowed or blocked. This prevents malicious processes from executing illegal system calls, while allowing normal processes to carry out their functions. Such security systems do not work on Android, which uses a distinctly different way of launching and managing its applications. In particular, the kernel is not aware of which processes corresponds to which application in the Android layer until a very late stage and therefore determining which applications may be attempting to communicate with each other via system calls is very difficult to ascertain.

The security system is suitable for the Android operating system or other computer architectures having similar structures or configuration. The security system utilizes an approach that allows monitoring user space code without the need to modify the

Android framework or the underlying Linux kernel. In particular, the security system provides a way to be configured to control Inter-Process Communication (IPC) or Inter-Component Communications (ICC) between applications to mitigate attacks that malware might perform on sensitive applications and their data. In principle, some embodiments herein are able to control and enforce security policies to any process running on an Android OS. This includes system services that are offered in stock Android (such as SMS service, Activity Manager, Service Manager, etc.). In this way, various embodiments mitigate vulnerabilities present in the Android services that might be exploited by malicious code.

The security system is implemented based on a feature unique to Android, namely the mother process called Zygote. Every Android application is run as a child process forked out from the Zygote mother process and then it specializes itself into the specific application by loading the specific application package and all the classes within it, and making use of Java reflection it will eventually start the application by invoking the static main method. In general, each time a new application is launched, the security system utilizes the Zygote process to configure a monitoring entity associated to the newly launched process at the Linux layer. This monitoring entity may in one form be an embedded process monitor method or function, such as additional code added to the new process' image in memory or, alternatively, in another form a separate process that is attached to and monitors the newly launched process. The security system is able to enforce a set of security policies, which can be provided by sources internal or external to the security system itself, such as a systems administrator, the device user, a third party service or system, an Android application, or a combination of these.

The security system enables the specification or configuration of application-specific security policies at the application layer, which can be enforced in the Linux layer. The security system will be described by way of example with specific reference to an Android operating system on an Android device. However, it will be appreciated that the security system may be configured to operate on any other suitable operating system having a similar architecture to Android or any other operating system or platform that, whether mobile or otherwise, uses a mother process to launch new processes in the Linux layer such as, but not limited to, the Linux operating system, a Unix operating system, or mobile operating systems like iOS for example.

The security system can be configured to monitor system calls that are performed by the kernel on behalf of processes. In particular, the security system is configured to monitor and implement security actions for system calls made by processes based on a security policy setting for the application corresponding to the process. The security action may include preventing system calls from executing, modifying system call parameters, modifying the returning values of the system calls, allowing system calls to execute depending on the security policy prescribed for the process initiating the system call or forcing the finalization of the process.

System calls are special functions that are performed by the Kernel on behalf of processes. They are viewed as low level operations that the Kernel executes as services for the processes to provide access to services managed by it. System calls are usually made available to user mode code through a system call number and a hardware interrupt, and are frequently invoked through library functions that are linked against the process code. In the Executable and Linkable Format (ELF), libraries are a special type of object code, which provides reusable symbols that can be imported from other object code. A special case of libraries are shared objects (or shared libraries), which are intended to be shared by executable files and other shared objects.

Shared objects can be either statically or dynamically linked. In the former case, the symbols are copied into the object file during linkage time, while in the later the symbols are resolved during execution. Dynamically linked symbols can be resolved either during the process image load into memory or the first time they are used, which is known as lazy binding.

The libc library is a common component on all Linux-based systems, and amongst other things, it provides a set of functions that can be used to invoke system calls from user mode code. Android provides its own libc implementation, namely Bionic libc. A special feature of Android, compared to a normal Linux configuration, is that the libc is linked dynamically to reduce the process memory footprint. This means that those symbols that are usually used by executables to invoke system calls are linked dynamically.

FIG. 2 provides an overview of this system call mechanism. By way of example, when a process 1 performs an ioctl system call 3 to the Binder 4, it actually invokes the ioctl function (2) provided by the libc.so 5. This function will invoke the ioctl system call 3 in the kernel and the operation will be executed 6 in supervisor mode.

The security system may monitor and intercept system calls made by monitored processes using various methods or a combination of methods, and may optionally dynamically switch between these methods in some embodiments. In a first example configuration, the security system may be configured to monitor system calls by performing System Call Interposition (SCI) which involves directly intercepting the interaction between the shared object library 5 and the system call gateway 7 in the kernel mode of the Linux layer. In particular, the security system may implement an SCI mechanism that monitors the execution of processes and directly detects and/or intercepts the system call 3 through the system call gateway 7 in the kernel mode of the Linux layer. Alternatively, in a second example configuration, the security system may be configured to monitor system calls by performing Function Call Interpositions (FCI) which involves intercepting function calls 2 from the process 1 to the shared object library 5 in the user mode of the Linux layer, where the set of function calls being monitored relate to those used to invoke system calls in the kernel mode. In particular, the security system may implement an FCI mechanism that monitors the execution of processes and detects and/or intercepts function calls to shared object libraries in the user mode that are intended to invoke system calls in the kernel mode.

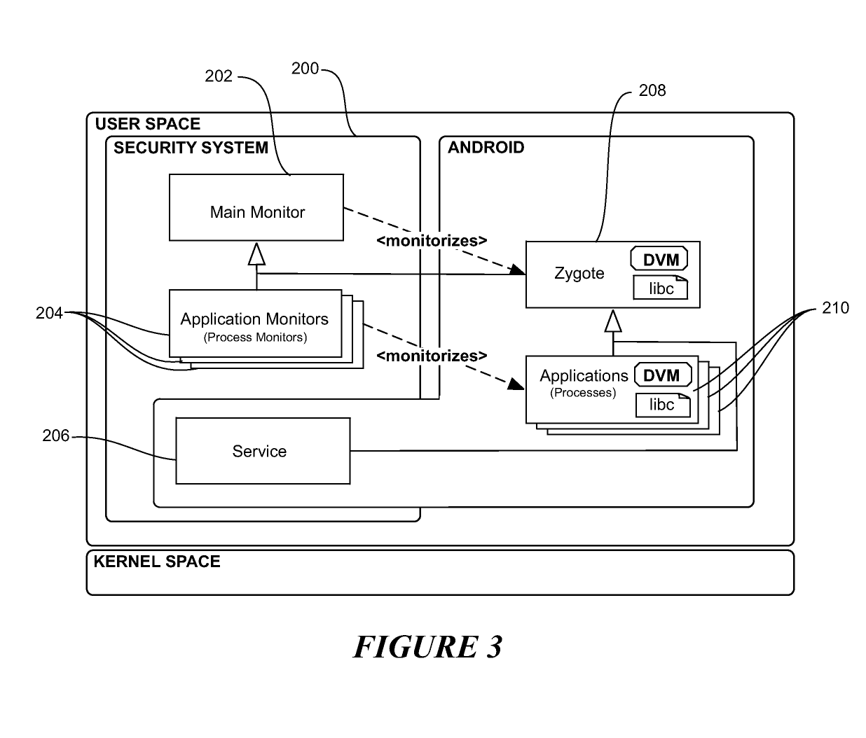

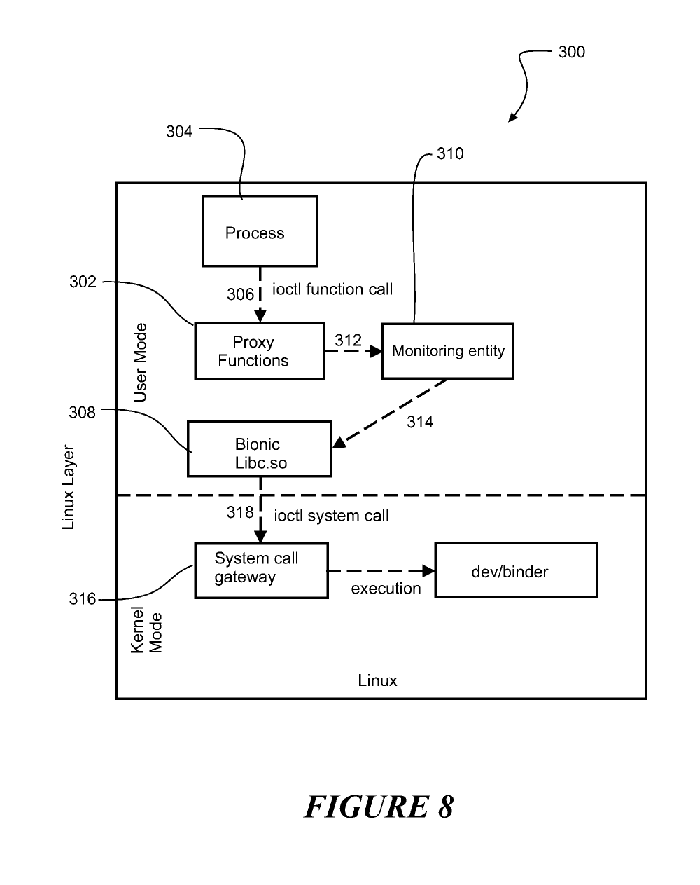

With reference to FIGS. 3-7, a first embodiment of the security system utilises SCI mechanisms or configurations will be described. With reference to FIGS. 8-11, a second embodiment of the security system will be described which utilises FCI mechanisms or configurations.

### 2. First Embodiment Security System—SCI Configuration

Overview

In this first embodiment, the security system runs a system process that attaches to the Zygote process and intercepts all its fork system call invocations, so that whenever a fork system call is intercepted, the security system starts monitoring the new process and enforcing the specific security policies for that specific Android application.

In this first embodiment, the security system generates a separate process monitor (monitoring entity) for monitoring each newly launched process in the Linux layer. Each process monitor is configured to implement an SCI mechanism to monitor and intercept system calls made by its target process.

In this first embodiment, the security system uses the support of the system call gateway to monitor system calls to the kernel. The security system configures or instructs the system call gateway to send a special signal to the process monitor associated with a target process each time that target process tries to invoke a system call in the kernel mode. In one example, this is achieved through the use of the ptrace system call. When a process monitor invokes ptrace to attach to a target process, each time the target process invokes a system call the gateway will suspend the target process and send a signal to its process monitor, and will then await a security action from that process monitor. The use of ptrace as an SCI interception mechanism will be described in more detail later.

The first embodiment security system will now be described in further detail with reference to FIGS. 3-7.

Main Components of Security System

Referring to FIG. 3, the first embodiment security system 200 comprises three main components or modules, namely a main monitor 202, application or process monitors 204, and a security system service 206.

The monitors 202, 204 (monitoring entities) are in charge of enforcing a set of security policies for one or more processes and are implemented as Linux processes. The monitors contain the policy enforcement point as well as the policy decision point, which will be described later. In this embodiment, there is a single main monitor 202 that is configured to monitor the Zygote system process 208. The rest of the process monitors 204 are forked out of this main monitor process. There may be zero or more application monitors 204, one for each Android application 210 that is forked out of the Zygote process. Process monitors 204 are created as children of the main monitor 202 when a fork system call from the Zygote process is intercepted. In contrast to the main monitor 202 that is configured to monitor the main Zygote thread, the individual process monitors 204 are configured to monitor all threads and sub-processes that belong to the application which they are attached.

The security system service 206 is configured as an Android service in the Application layer that provides access to all the Android framework functionality in the Android layer to the monitors 202, 204. In this embodiment, the monitors 202, 204 in the Linux layer communicate with the security system service 206 in the Application layer using a client-server communication configuration such as, but not limited to, internal Unix sockets.

Example Configuration and Operation

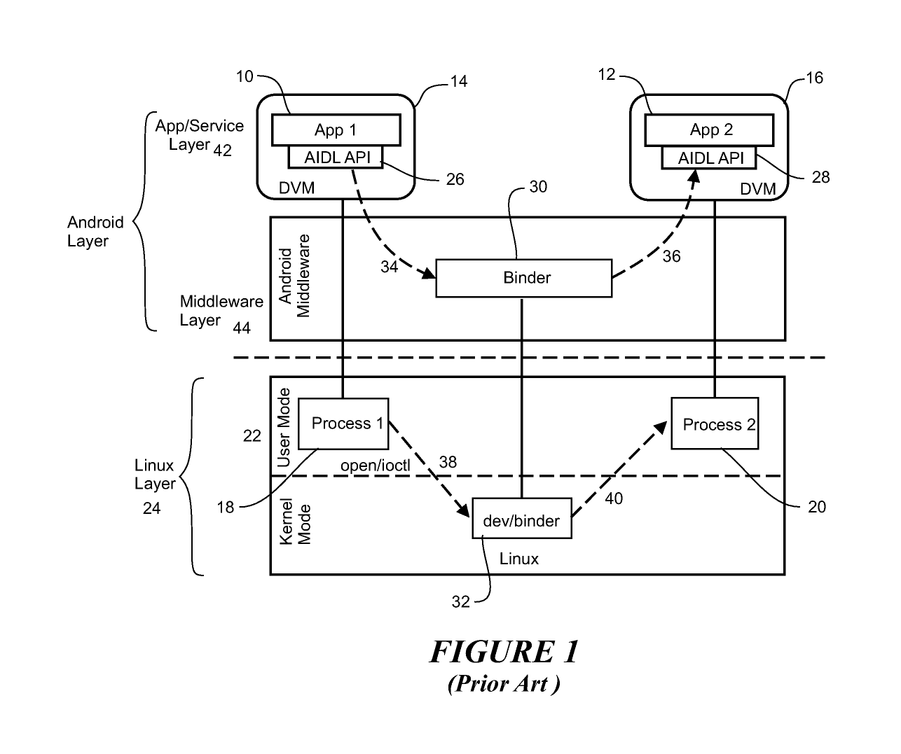

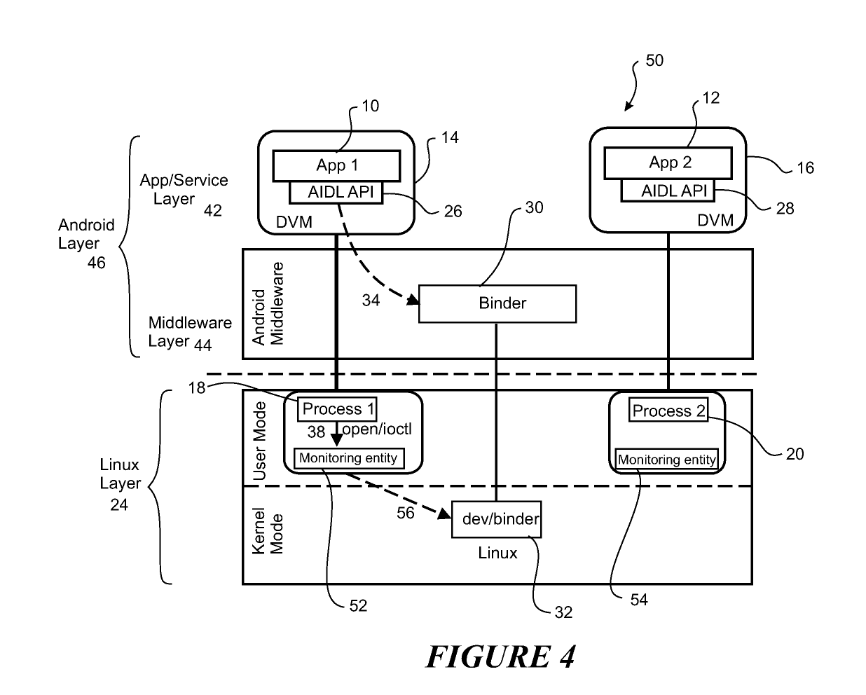

Further explanation of the security system configuration and functionality of the main modules will now be described with reference to the example in FIGS. 4-6. FIG. 4 corresponds to the architecture described in FIG. 1 and like numerals represent like components. In brief, each Linux process 18, 20, in the Linux layer that belongs to an Android application 10, 12 has its own attached process monitor shown at 52, 54 respectively. Each process monitor 52, 54 is configured to intercept all or a subset of the system calls that the attached Linux process 18, 20 executes on behalf of its associated application 10, 12. When each Linux process executes a system call, the attached process monitor intercepts the system call and undertakes a security action based on a security policy associated with the application, which indicates whether the Linux process has authorization to execute that system call. By way of example, the process monitor may be configured to allow the system call, block the system call, modify the parameters of the system call, modify the values returned by the system call or other suitable security action, or a combination of these. If the Linux process is authorised to execute the system call, the process monitor lets the execution of the system call proceed. Alternatively, the process monitor may block the system call from executing or otherwise modify the system call parameters or return values. For example, the process monitor is able to retrieve the parameters of the system call and additionally the values that the system call returns. This enables the process monitor to modify the system call, for example by filtering out one or more return values or changing or modifying one or more parameters of the system call prior to execution depending on the configured security policy for the application. Additionally, security actions can be taken depending on the value of a system call's parameters. By way of example, the process monitor may be configured to modify the system call rather than blocking the system call for application that may crash as a result of a blocked system call.

By way of example, the process monitor 52 may be configured to intercept IPC, which uses system calls 34 to interface the Binder subsystem 30. This can be done by intercepting the open and ioctl system calls 38 which destination is the binder kernel driver 32. The process monitor 52 then decides based on the security policy configured for the associated application 10 in the application layer and other parameters extracted from the process execution state whether to block the system call or otherwise allow the system call to proceed in its original or a modified state as shown at 56.

Each process monitor is created by the main monitor which is a Linux process created at boot-up of the device before the initiation of any application and which will be explained in further detail later. The security policy dictating the authorizations of applications installed on the device in the application layer and in particular which application may communicate with each other or employ each other's services or permissions or other sensitive stored data is configurable and stored and/or retrieved by a security system server in the application layer which will be described in further detail later. The security policies may be stored in memory locally on the device or remotely on an external storage capacity, server or network accessible by the device.

Each process monitor is attached to its corresponding Linux process by establishing the process monitor as the master process and associated Linux process as its target process and using a tracing system call that is configured to enable a master process to control a target process by inspecting its memory and registers and intercepting its system call invocations. In this embodiment, the tracing system call is the process trace system call (ptrace). To use ptrace, the master process has to be either running as the root user or the same user as the target process. The master process will become the parent of the target process and will be able to monitor and control all the child processes and threads that are created by the target process.

As mentioned, the security system is configured to monitor all applications and corresponding processes executed on the Android device by exploiting a configuration feature of the Android OS, which controls the management and launching of applications. In Android, all applications in the application layer are launched by a special mother process, known as the Zygote process. The Zygote process is the only process that has the right to create a new Android application and its corresponding Linux process. Hence, all Android applications and their corresponding Linux processes execute on Android are in practice children of this Zygote process. The configuration of the security system and operation of the main modules will now be described in further detail.

Security System Start-Up

The security system starts as a part of the Android operating system. As mentioned, the security system controls the mother or Zygote process so that every time a new Linux process (corresponding to an Android application) is started, a new monitor can be attached to the process. Controlling the Zygote processes achieved by modifying the booting sequence of the Android operating system.

By way of example, the booting sequence is modified such that the main monitor of the security system replaces the initial Zygote process. During the boot process the initialization script is run and the main monitor is started. The Zygote process is then launched as a child of the main monitor. The main monitor then executes a tracing system call, such as ptrace(request=PTRACE_ATTACH), to attach to the child Zygote process to control its execution from the first moment it begins, by intercepting system calls to the kernel made by the Zygote process. In particular, the ptrace(request=PTRACE_SYSCALL) system call is used to notify the kernel that the main monitor should receive a notification every time the target Zygote process enters or exits to and from a system call. At this point in boot-up, the main monitor is now attached to and monitoring the Zygote process.

In this embodiment, the security system service is also started by the Android operating system during the boot process. By way of example, the security system service is located within the directory for system applications such that it launches before a user can log-in or any user application can be run on the Android device. Once the security system service is running, every time a new Android application is forked from Zygote, a new process monitor is forked from the main monitor and attached to the new application process, as explained in further detail next.

Generation of Process Monitors for Newly Launched Android Applications

Overview

The sequence of main operations executed by the security system to generate and configure a process monitor for a newly launched Android application will be described. When the security system starts, only the main monitor process is running, along with the security system service. The main monitor is attached to and monitoring the Zygote process. New process monitors are created as children of the main monitor as a result of the fork system call invocations made by the Zygote process, which is called every time a new application is launched in Android. In particular, the main monitor is configured to detect the fork system call invocations made by the Zygote process, and create a new process monitor for each new application launched.

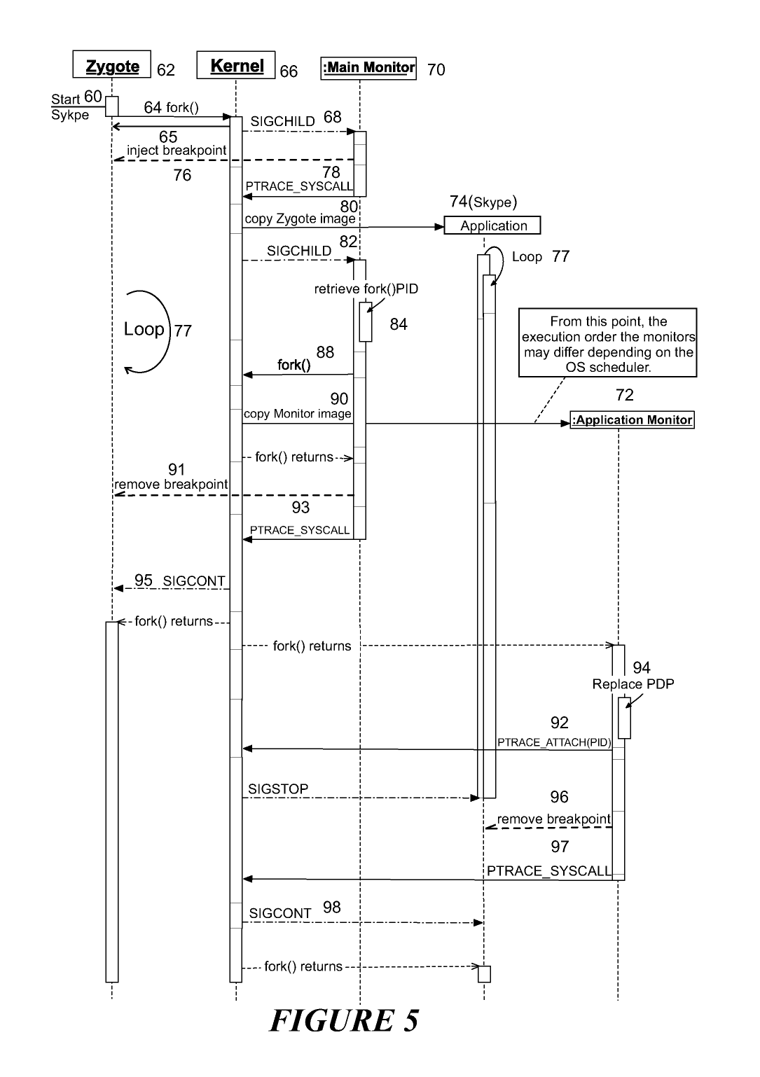

Referring to FIG. 5, the scenario of a user launching the Skype application on their Android smartphone will be used by way of example. When the user clicks on the Skype icon on their smartphone a message or signal 60 is sent to the Zygote process 62 to fork a new process 74 that executes in a copy of the DVM for the Skype application.

Every time Zygote 62 invokes a fork system call 64, it will be suspended 65 by the kernel 66 and the main monitor 70 will be notified by the kernel via a signal 68 (e.g. SIGCHILD) and woken up. The kernel dispatches these signals because the main monitor 70 is monitoring Zygote 62 through the ptrace system call. A new process monitor 72 is now be created by invoking the fork system call from the main monitor 70 and once forked, it will attach to the newly created process 74.

Due to the scheduling performed by the Linux scheduler, there's no way to guarantee that the process execution order will allow the new process monitor 72 to attach to the new Linux process 74 corresponding to the Skype application before it executes any system calls. In some circumstances, the new process 74 could start executing its code without the process monitor 72 be able to control it, which could lead to security issues.

In order to avoid this situation, the main monitor is configured to inject a breakpoint 76 (e.g. an endless loop 77) into the Zygote process code, so that when its image is duplicated to create the new process 74, the new copy will contain that breakpoint as well. The new process 74, now containing the breakpoint 77, is initially stuck inside it, so will not be able to execute any other code until the breakpoint is removed by the process monitor. This is performed right after the process monitor 72 has effectively attached by means of ptrace to the new process 74. By way of example, the breakpoint may be a breakpoint machine instruction, an infinite loop in ARM assembly code or any other equivalent method of stalling program execution on processors that use other instruction sets. An example of the breakpoint injection for this embodiment and the remaining process monitor 72 generation will be further described below.

Breakpoint Injection

As set out above, every time a new Android application 74 forks from Zygote 62, the security system injects a breakpoint 76 into Zygote 62 so that when its image is duplicated, the new process 74 will contain the breakpoint as well and the new process monitor 72 can attach to it before it continues its execution without missing any system calls.

As mentioned, the “breakpoint” 76 may be, for example, an infinite loop in ARM assembly code. The breakpoint is injected 76 at the current program counter address (PC) within the Zygote process memory as follows using the following procedure. Firstly, in order to resume the Zygote program execution, the state of Zygote registers should be backed-up in the memory of the main monitor 70, as well as the Zygote program code that will be replaced by the breakpoint itself By way of example, the main monitor 70 may copy part of the Zygote process image into its own memory using ptrace(PTRACE_PEEKDATA) which allows to read data from the monitored process memory, in this case Zygote. The main monitor may read and store the state of the Zygote process registers in its own memory using ptrace(PTRACE_GETREGS). After this, the main monitor 70 is configured to reset the PC to its previous address (that will later contain the breakpoint) so that it continues its execution at the breakpoint code injected. The register R1 of Zygote 62 is set to zero using ptrace(PTRACE_SETREGS), which enables the breakpoint. Next, the main monitor is configured to inject the breakpoint code into Zygote. The main monitor 70 contains a function that contains inline ARM assembly code that executes an infinite loop (based on the value of R1), and this is the code that is injected into the Zygote process memory. The breakpoint function machine code is obtained from the function address in the main monitor memory as an array of bytes. Then the breakpoint code is copied from the main monitor memory into the Zygote memory at the program counter address using ptrace(PTRACE_POKEDATA) which allows the tracer to insert data into the monitored process memory space.

New Process Creation, After Breakpoint Injection

Once the breakpoint code has been inserted into Zygote as above, the main monitor 70 invokes ptrace(PTRACE_SYSCALL) 78 to notify the kernel to allow the kernel space code of the Zygote fork system call to execute. As the fork system call executes 80, a new process 74 (intended to eventually be Skype in this example) is created. The new process 74 is a clone of Zygote 62, which means that it is a duplicate of the Zygote process image in memory, including the injected breakpoint. The newly created process 74 may then run, but will be stalled in the breakpoint loop 77. The main monitor 70 is then configured to wait until it receives the fork system call exit notification. In particular, the main monitor 70 is configured to monitor for the exit notification and intercept it.

New Process Monitor Creation

When the fork system call returns in Zygote (the system call is exiting), the process will be still stopped 66 and the kernel will notify the main monitor 70 via signal 82 (e.g. SIGCHILD). At this point, the Process Identification (PID) of the new process 74 is already available as it's provided as the return value of the fork system call. Each process has a unique PID that allows the kernel to identify the different processes running. The main monitor 70 is configured to retrieve the PID of the new process 74 as shown at 84 from Zygote. For example, the main monitor 70 may retrieve the PID from the Zygote process register R0 using ptrace(PTRACE_GETREGS). The main monitor 70 is then configured to generate a new process monitor 72 which will attach to that retrieved PID.

The main monitor 70 forks the new process monitor 72 by executing a fork system call 88 to the kernel 66. When the main monitor process forks 90 a new process, the newly created process monitor 72 is at the beginning of its execution an exact replica of the parent main monitor process. This means that when the main monitor 70 forks the new process monitor 72, the process monitor has in its memory the PID of the new process 74 (intend to eventually be Skype) created by Zygote 62 and retrieved from the Zygote registers.

The main monitor 70 is then configured to replace the breakpoint code in Zygote 62 with the original code backup at the original location using ptrace(PTRACE_POKEDATA) and resets the registers to their original stored values using ptrace(PTRACE_SETREGS) as shown at 91. The main monitor then resets the PC of Zygote to its backed up value and requests the kernel to continue the Zygote process by means of ptrace(PTRACE_SYSCALL) 93, resuming the Zygote process via a SIGCONT signal 95, and waiting for further fork invocations.

The newly created child process monitor 72 uses the PID in its memory to attach itself to trace the new Skype process using ptrace(PTRACE_ATTACH) as shown at 92. The process monitor 72 is also configured to replace a main dummy policy decision point from the main monitor with one specific for application it is monitoring as shown at 94, which will not yet contain any security policies until the application package name (in this case Skype) associated with the monitored new process 74 is known. Once attached, the process monitor 72 is able to trace the new process 74, so it can be configured to replace the breakpoint code in the new process 74 with the original code as shown at 96, and initiate execution of the new process by means of ptrace(PTRACE_SYSCALL) 97, which will deliver SIGCONT 98 to the new process 74. This is done in a similar manner to the way the main monitor 70 replaced the breakpoint code in the Zygote process 62, as discussed above. The monitored new process 74 can now start executing. As the process monitor 72 is attached to the new process 74, it can intercept and control all the system calls that this process executes.

Configuration of Security Policy for New Process Monitor

At this point, there will be the main monitor 70 tracing/monitoring Zygote 62, and a new process monitor 72 tracing/monitoring the newly created Linux process 74 which hasn't specialized into the Skype Android application yet. The new Linux process 74 is not yet executing the code of the Skype application and at this early stage there's no way to know which application the process will belong to. This means that the specific security policy for the new process monitor 72 cannot be loaded until the new process 74 specializes. The security system is configured to retrieve and load a specific security policy or set of policies to the new process monitor 72 based on application identification data that is indicative of the Android application the new Linux process 74 is specializing as. In this embodiment, the application identification data is the application's package name and the process monitor 72 is configured to retrieve this during the specialization of the new process 74 it is monitoring.

To specialize, the new process 74 needs to retrieve the get access to the Skype application package name so that it can then load the Skype application specific bytecode from the application database on the device for execution. During the specialization process or stage, the Android framework writes the application's package name into a specialization file (e.g. /proc/self/cmdline within the /proc pseudo-filesystem). This occurs right after the new process 74 is forked and before the static main method is invoked using reflection, which means that no developer code has been executed yet.

The Android Process Java class (android.os.Process) invokes, through the Java Native Interface (JNI), the function android_os_Process_setArgV0 setting the package name as parameter. This will internally call the ProcessState::setArgV0( ) method which resets the process argv[0], which effectively changes the specialization data file (i.e. updates it with the application's package name) and then after this sets the process name by using the prctl(PR_SET_NAME) system call. The process name that can be set through the prctl( ) system call is limited to 16 bytes, which means that in some cases, the package name in this system call might not be complete. There are no system calls generated by the monitored process 74 when the argv[0] parameter is set into the specialization data file, which actually contains the whole package name.

In this embodiment, instead of checking the application name specified by the prctl( ) function parameters, the process monitor 72 is configured to read the contents of the specialization data file which contains the full application package name, set when the argv[0] was overwritten. In particular, the process monitor 72 is configured to detect when the prctl( ) system call is exiting with the PR_SET_NAME value set. Once this is detected, the process monitor 72 knows that the full application package name has now been written to the specialization data file. The process monitor 72 is configured to then read and retrieve the full application package name from the specialization data file upon detection of the prctl( ) system call exiting.

Once the package name (e.g. com.skype.apk) has been obtained by the process monitor 72, it can then retrieve and load the security policy or policies specific to that application. In particular, the process monitor policies can be initialized and policies can be enforced specific to that process. The package name is forwarded to the process monitor's policy decision point, which will load the specific policies for the monitored process. To do this, the process monitor 74 may make use of a special service in the application layer framework called the security system service, which will be described in further detail later on.

Operation of Monitors

Overview

Each process monitor is configured to enforce the retrieved security policy for its attached new process by implementing a security action at the Linux layer in regard to the detected system call based on the retrieved security policy. The security action may comprise any one or more of the following: allowing the system call to proceed, blocking the system call from proceeding, or modifying parameters of the system call prior to execution or return values generated by the system call after execution. By way of example, the monitor process may implement a security action by instructing and controlling the kernel in regard to its execution of the requested system call by the attached monitored process. An example implementation of the enforcement of policies is explained below, although it will be appreciated that alternative enforcement mechanisms may be used.

In this embodiment, the main monitor and process monitors each contain two components, namely a policy enforcement point and a policy decision point. The policy enforcement point is in charge of tracing the monitored process through its system calls and enforcing the policies and provides the information from the process state to the policy decision point. The policy decision point generates decisions based on the process state and the policies assigned to it. These decisions are sent to the enforcement point, which makes sure they are enforced.

The policy decision point uses a policies repository, which depends on the security system configuration for each decision point, and that might change on runtime if the configuration is eventually modified. Depending on which type the monitor belongs to (e.g. main monitor or an individual process monitor) it will contain a different type of policy decision point.

The main monitor contains a dummy decision point that is used to intercept the fork( ) system call and retrieve the PID of the new process in order to generate new application process monitors, as explained previously.

In contrast, the process monitors are able to retrieve the application package name associated with their respective target process and perform the policy initialization. By way of example, there may be various types of policies supported by the process monitors, such as:
IPC interception: Intercepts Inter-Process Calls generated from the monitored process. In order to do so, it intercepts those ioctl( ) system calls which destination is the Binder pseudo-device (/dev/binder).
Networking: Controls communication through TCP/IP or other network protocols between different processes running either locally or remotely. This includes control over which external servers, clients or peer to peer networks (for example over the Internet) a process can contact.
Shared memory: block inter-process communication through shared memory. Specifically block access to the various Android shared memory services Android shared memory (ashmem), Process memory allocator (PMEM and processor specific variants (CMEM, NVMAP, etc.) and the Android ION memory allocator. Furthermore, a child process can be prevented to use shared memory mechanisms with its parent.
File system: Block certain processes to access, create, read, modify and/or write to a specific file or folder in the file system. Establishes disk quotas for a given application and can provide a sandboxed environment so that each application has access to its own virtual file system.
Telephony, Short Message Service (SMS) and Multimedia Messaging Service (MMS): block a process to access Telephony, SMS and/or MMS services on Android. If needed, a policy can be set to prevent that a process initiates Telephone calls or sends SMS or MMS messages to a specific number or contact.
Subscriber Identity Module (SIM) access: block a process from accessing sensitive information from the SIM card installed in the device; such as the Integrated Circuit Card Identifier (ICCID), International Mobile Subscriber Identity (IMSI), Authentication key (Ki), Location Area Identity (LAI), stored SMS messages, Unstructured Supplementary Service Data (USSD) codes and contacts lists.
Sensor and other hardware access: block a process from accessing sensors and other types of input or output hardware that may be present in the device; such as camera sensors, microphones, light sensors, Global Positioning System (GPS) receiver, motion sensors, accelerometers, gyroscopes, keyboards, buttons, displays, projectors, printers.
Near Field Communication: block a process from using Near Field Communication (NFC) or other types of wireless communication to establish a new connection or monitor a communication session that is already in progress.
Enterprise Right Management (ERM) policies: policies for manipulating enterprise or digital assets. Digital assets are intended to refer to files stored on the device, in either storage memory or runtime memory. The files may for example define applications or other data, such as, but not limited to, SMS, emails, pictures or any other item of data that carries or defines information. With an ERM policy, the entity owning the digital asset (e.g. an enterprise or organization) retains control of the digital asset lifecycle management when an application on a device attempts to access the digital asset. ERM policies can be configured and enforced to control the way the digital asset is used, or to trigger modification of the digital asset or its complete deletion from the device. The ERM policies can be configured to cause a security action to be performed before access to the digital asset is performed by an application, after the access to the digital asset has been concluded, or both. The ERM policies can be configured to cause a security action to be performed on the files being accessed whether they are in storage memory or runtime memory (e.g. RAM). By way of example, the ERM policies can define any one or more of the following security actions to be performed before an application accesses a digital asset:
   modification of the digital asset to remove or add information, e.g:
      sanitizing—remove or filter out any information that should not be disclosed to the application accessing the digital asset
      versioning—add information related to the version of the digital asset
      watermarking/fingerprinting—adding tamperproof information into the digital asset
      timestamping—adding timing information of the access to the digital asset
   decrypting the digital asset if it was encrypted
   deleting the digital asset
   controlling how many times the digital asset can be read and/or modified, e.g:
      counting read/write accesses
      recording the amount of data read and/or modified
   logging access information (such as context)
By way of example, the ERM policies can define any one or more of the following security actions to be performed after an application has concluded its access to a digital asset:
   modification of the digital asset to remove or add information, e.g: sanitizing, versioning, watermarking/fingerprinting, and/or timestamping as above
   encrypting the digital asset
   deleting the digital asset

These policies are loaded with the specific policy configuration associated with application package name in a policy database, stored on the device or remotely accessible. The policies may be modified and updated during the application execution if desired. Some policies, or any other components within the monitors, may need to get access to functionality that is only available from the Android application layer but not from the native code layer, such as access to the GUI or the different Android system services like the Package Manager, Activity Manager and so on. The monitors can use such Android Framework functionality through querying the security system service running in the application layer using transactions, as will be explained further later.

Policy Enforcement Mechanism

As discussed, the main monitor 70 and process monitors are processes in the Linux layer that are attached to Zygote and any application processes, respectively. A tracing system call is used to attach the main monitor 70 and process monitors to their respective target processes. In this embodiment, the process trace (ptrace) system call is used to attach the main monitor 70 to its target process, namely the Zygote process 62, and each process monitor to its respective target processes. The target processes become the child of their respective monitor or parent process once the ptrace system call is executed to attach the monitor to the target.

In regard to the process monitors, ptrace is configured to trace the target process main thread (by default) and also the rest of process threads and sub-processes, in this embodiment. Such tracing is helpful in some embodiments, such as with regard to Android applications, which are typically multi-threaded applications. By configuring ptrace in such way, this ensures that the process monitors will receive notifications of any system calls executed by every single thread and process that descends from the root application process.

The policy enforcement mechanism takes place in the policy enforcement point within each monitor. The policy enforcement point enforces the policies by tracing the monitored process system calls, and making decisions based on the information that can be extracted from them.

The process monitors attach to their respective target processess (using e.g. ptrace(PTRACE_ATTACH)) and then they notify the kernel they should be notified every time their target process executes a system call (using e.g. ptrace(PTRACE_SYSCALL)).

Once this setup has been performed, the process monitors go to sleep (e.g. invokes waitpid( )) after attaching to the monitored target process. This blocks the process monitor until a system call is invoked by the monitored target process. When a system call is made by the target process, the kernel will suspend the target process execution and will unblock the process monitor (e.g. using SIGCHILD signal). The waitpid( ) function will return the ID of the thread (TID) that generated the system call as well as some additional process state information that is used for other purposes. At this point the process monitor is configured to retrieve the state of the monitored process registers, from where the system call number can be obtained. The thread ID, system call number and the state of the process registers are forwarded to the policy decision point, that depending on its policies, will consider the system call relevant or not. If it is not relevant, it will return immediately with no decision to the enforcement point. If it is relevant, the policy decision point will analyze the process state and depending on it, it may or may not return a decision to the enforcement point, e.g. a security action to execute. The decision generation mechanism is explained in further detail later. After the decision point returns, the enforcement will continue the monitored process if the decision indicates to do so or implement any other security action indicated by the decision, including blocking the system call, modifying parameters of the system call or return values, requesting user input for implementing user-selected security actions, or even killing the application process altogether. In case the process is allowed to continue and after the decision is enforced, the process monitor will notify the kernel to continue the process execution (eg. ptrace(PTRACE_SYSCALL)) and goes back to sleep (e.g. invokes waitpid( )) waiting for notification of the next system call made by the target monitored process.

Policy Generation Mechanism

Decisions are security actions that have to be executed in order to enforce a set of policies. The policy decision point within each process monitor is the component in charge of the decision generation, which takes place every time the policy enforcement point intercepts a system call. In this embodiment, each policy decision point contains a set of policies, depending on the monitor type and the security system configuration for the monitored application. These policies, also known as low-level policies, in contrast to user-defined policies (those that are specified in the application layer), are defined within the security system itself A user-defined policy can be translated into one or more low-level policies and can affect one or more monitors depending on its semantics.

The enforcement point triggers the decision generation mechanism. After intercepting a system call, it retrieves the state of the registers for the process that generated it and checks if such call is either entering or exiting. The policy decision point, as well as policies, have two entry points, one for the entering system calls, and another for the exiting ones. This is due to that the information that can be retrieved at each point is different so different decisions can be made during each stage. Then, the enforcement point forwards to the specific entry point within the decision point the system call number, the state of the process registers, and the TID that generated such system call, (this information being referred herein as the process state). The process state is passed to each one of the policies that may or may not return a decision. In one form, just the first decision returned by a policy is taken into account, and the rest are discarded. In another forms this could be modified by assigning different priorities to each policy or using other selection mechanisms. In this embodiment, even if a decision has already been generated by one of the policies, the process state is still passed to the rest of policies, in case they need it to track the process history.

In this embodiment, policies are not monolithic components, they are made instead of reusable modules that can belong to one or more policies know as action modules. Action modules are associated to a unique system call and extract information from the process state, in order to provide information that can be used by the policy to generate a decision. Action modules, the same as the decision point and policies themselves provide two entry points, one for the entering system calls and another one for those that exit, but in contrast to them, they are specific for each thread, so they don't need the thread identifier except at the time they are built. Each policy specifies a list of action modules that is instantiated for each thread and running within the monitored Android application (as well as sub-processes), in such way so that whenever a policy entry point is invoked, if the list of action modules for that thread does not exist, it is created, and it is removed once the thread or process exits. With this approach, each thread execution can be tracked independently and additional security checks could be performed.

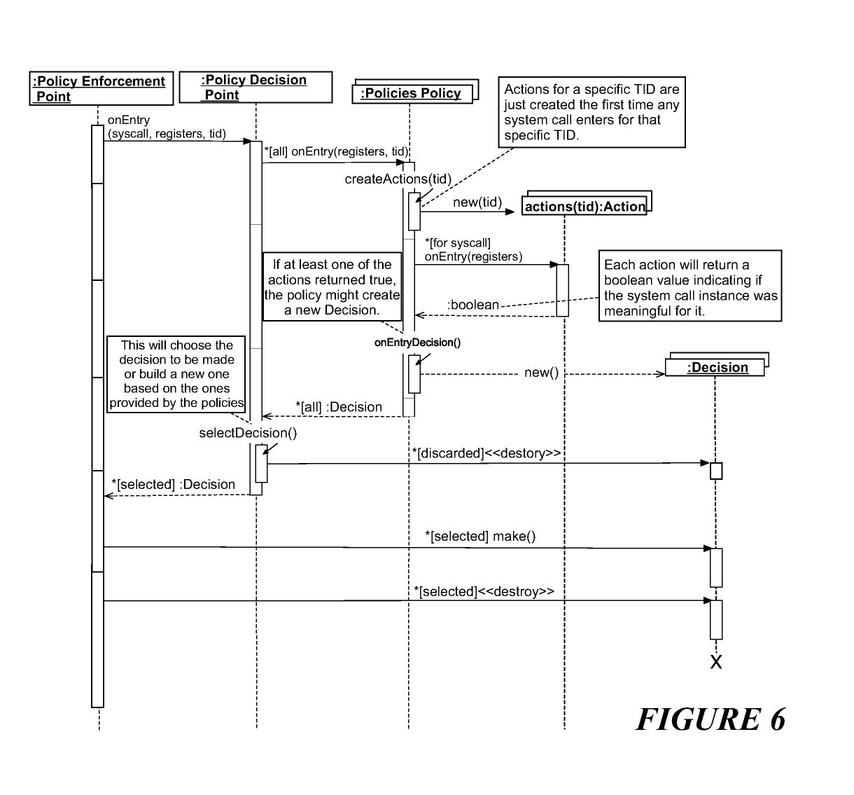

When the policy entry point is invoked, it will loop over all the actions for the TID that generated the system call that are associated to that specific system call. Should any of these action modules consider the system call invocation is meaningful for it (for instance, ioctl( ) on some specific device or open( ) on just socket descriptors), the policy will check the data gathered by those action modules and generate a decision (security action). The decision is then returned to the policy decision point, which will decide if should be sent back to the enforcement point or not depending on the other policies results. Finally, if the decision point has returned any decision, the enforcement point will ensure the decision is made in order to enforce the policy that generated it. This process is shown diagrammatically in FIG. 6.

Security System Service

Overview

The security system service is an Android system service in the application layer that exposes all the Android Framework functionality to the monitors in the Linux layer. It runs on start-up, before any user application. In contrast to normal Android services that provide services to other Android applications or services, this service does not expose its functionality through intent action filters or an AIDL interface in this embodiment. Instead, the security system service provides its functionality to the process monitors through a communication link or process between the application layer and Linux layer. In this embodiment, the communication between the security system service in the application layer and the process monitors in the Linux layer occurs via requests to a Unix socket, i.e. the security system service listens for requests on a TCP port. These requests are known as transactions. Each transaction has a unique ID and may contain zero or more parameters that are set by the process monitor and processed in the service, which eventually returns a result back to the process monitor.

Each transaction has a client part, that is the process monitor, and a server part represented by the security system service. The client part sets the transaction identifier (transaction ID) and the parameters and sends them serialized through a socket to the security system service. Transactions are synchronous, so the process monitor gets blocked waiting until the transaction has been processed. The security system service is configured to wait for requests on the security system service socket. Every time a new transaction is received, the security system service retrieves the transaction ID, and builds the server part of the transaction, which deserializes the parameters from the socket, and the new transaction is put into a thread pool queue. Once there is an available thread to process the transaction, the transaction runs and performs its functionality. It will return and a serialized result will be sent to the requesting process monitor. To finish the process, the process monitor receives the transaction response, which is deserialized, and will unblock, continuing its execution. In this embodiment, the communication link may use Transport Layer Security (TLS) for protecting the confidentiality of the communication between the security system service and the process monitors. It will be appreciated that other communication links or mechanisms could be used to enable communication between the security system server and process monitors in other implementations, including, but not limited to, shared memory space or similar.

The security system service, operating in the application layer for accessing the services of the Android framework, allows the specification of per-application policies through the standard Android interface (such as an Application for example). Also, it allows the process monitors to deal with the specific way in which Android implements IPC calls. The security system service provides to the process monitors an entry point to the upper level of Android services and in doing so the process monitor is able to enforce its policies. These aspects are explained further below.

### EXAMPLE

### Setting a Security Policy

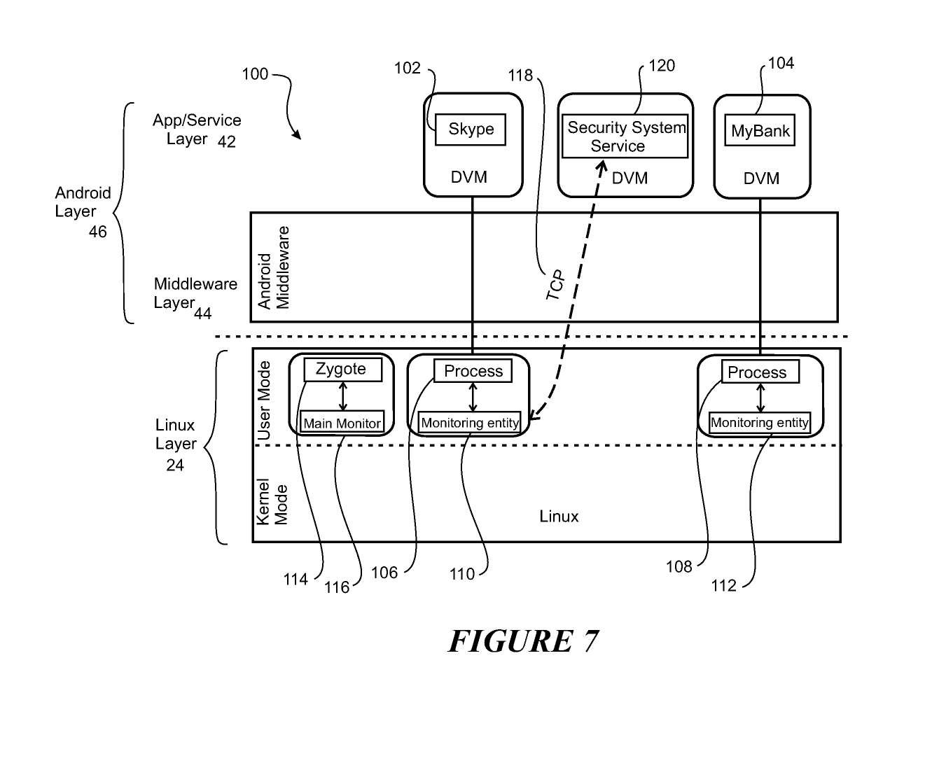

Referring to FIG. 7, an example implementation of the security system showing the functionality of the security system service on an Android device 100 will be described by way of example. The Android device has a Skype application 102 and MyBank application 104 running in the application layer 42, each having or being mapped to a corresponding Linux process 106, 108 respectively in the Linux layer 24. Attached to each Linux process 106, 108 is a corresponding process monitor 110, 112 respectively. Zygote 114 and its attached main monitor 116 are also shown in the Linux Layer. The security system service 120 is shown running in the application layer 42 as a normal Android service. By way of example, a TCP communication link is shown between the process monitor 110 associated with the Skype application and the security system service 118, and a similar communication link exists or can be established between any other process monitors and the security system service also.

The process monitor 110 attached to the Skype application can use the functionality of the security system service 120 for loading policies specific to the Skype application. In particular, when the process monitor 110 is configuring itself, it retrieves the application package name associated with the process 106 to which it is attached (as previously explained) and then uses this application identification data to request the security policy or policies for that application from the security system service 120, which has access to the policy database, such as a policy configuration file where the policies are stored. The security policies for the applications may be stored in a policy configuration file on the device permanent storage, in memory or alternatively in a remote location on a server or network or other device accessible by the security system service. The security policies may be configured and stored in the policy configuration file in various ways. The policies may be configured via a custom security system application with a GUI that can be launched on the application layer and operated by the user or system administrator, automatically set by virtue of the application permissions during application installation, retrieved from a network or server operated by a third party, or may be configured in any other suitable way.

By way of example, the MyBank application 104 is a sensitive application that the user wants to protect. The user does not trust the Skype application 102 to call through IPC the MyBank application. The security administrator can define a high level policy such as: Skype not Auth IPC to MyBank. This policy has to be translated in the low level policy that the process monitor 110 can enforce. For instance, for controlling IPC communication between applications, a low level policy may be implemented such as: IPCPolicies that deny an IPC call between the application represented by the “CallingAppPackName” and the application in the “TargetAppPackName”. The policy might be: DenyIPCPolicies(CallingAppPackName,TargetAppPackName, Type). This policy takes as argument the package name of the calling application, the package name of the target application and a parameter specifying if the target is either an application or a service. For our case, when the process monitor 110 attached to Skype contacts the security system service 120 to request the Skype policies when initializing, the security system service will retrieve the relevant policies from the policy database and reply with the parameters specifying the package name for Skype, for the MyBank app and that MyBank is an application. The process monitor 110 can then load the IPC policy as follows: DenyIPCPolicies(“com.skype.app”,“com.mybank.app”, APPLICATION).

Monitoring IPC System Calls

In this embodiment, the other main functionality of the security system service is to help process monitors resolve the application name its attached monitored process is trying to communicate with, so that it can then enforce any particular policies in relation to that IPC. In Android, the IPC call mechanism uses a special type of messages for performing the remote method invocation called ‘intents’. An intent represents an abstraction of a remote procedure call and is the main way in which the Binder manages the IPC between different applications. There are two types of intent supported in Android: explicit and implicit intents. Explicit intents define which application is the receiver of the intent. The process monitor can directly capture explicit intents and extract the target application (or its package name) from the associated system call parameters being executed by the monitored process. Implicit intents specify the action that should be performed, but not the target application or service. Then it is up to the Android framework to find the best matching destination for the intent. Android run-time and specifically Activity Manager decides which activity would be the target of the intent. Activity manager contacts the Package Manager to resolve implicit intents. Package manager is one of the system services which maintain some information about the installed applications and services on the Android device.

From the process monitor point of view, when its monitored application is executing an IPC system call using an implicit intent, the process monitor is able to capture the intent and extract its contents, but the extracted information is not enough for evaluating its security policies. An IPC security policy needs as a parameter the target application, but implicit intents only provide the description of the requested service. Because the Package Manager is a service running in application layer on top of Android, the process monitor is not able to access it directly. However, the process monitor is configured to interact and communicate with the security system service running on the application layer via a Unix socket, and can send a request for information indicative of the target application associated with the implicit intent to the security system service, so that it can enforce and relevant security policies in relation to that intent.

For example, with reference to FIG. 7, let's assume that the MyBank application 104 has a method “myPrecious” that is invoked for “getting some precious stuff”, and that the Skype application 102 wants to send an implicit intent to an application that has the “myPrecious” method with the description “getting some precious stuff”. In Android (without the security system installed), when the Skype application 102 sends the intent through the Binder, the Binder will ask the Package Manager which app has the “myPrecious” method with the description “getting some precious stuff”. The Package Manger will reply with the MyBank application 104. Thus the Binder will send the intent to the MyBank application that will reply to the request giving to the Skype application 102 the precious stuff, which could lead to security issues. When the security system is installed on the Android device, the above process changes as explained below to minimise such security risks.

When the security system is installed on the Android device such that a process monitor 110 is attached to the Skype application, it will intercept the system call that is generated when the implicit intent is sent from Skype application to the Binder. The process monitor 110 is configured to retrieve the information in the intent but initially the policies in the process monitor can't determine the package name of the target application, which is not yet known. The process monitor 110 cannot access the Package Manager in the Android layer directly, but the security system service 120 can as it is a standard Android service running at the application layer on top of Android with a special communication link for the process monitors, i.e. the TCP connections. When the process monitor 110 intercepts the system call with the implicit intent, it is configured to copy the application description and method, and sends it to the security system service 120 through the TCP link 118 with a request for the package name of the target application. The security system service 120 is configured to receive and processes the transaction, and asks the Package Manger to provide the package name of the target application that satisfies the description based on its configuration. The Package Manger will return the “com.mybank.app” package name to the security system service that will forward it to the process monitor 110 using the same TCP link 118. Now, the process monitor 110 has the package name information and can evaluate and enforce its security policies. In this, case the policy described above will be evaluated and since it is a deny policy, the action will be denied.

### 3. Second Embodiment Security System—FCI Configuration

Overview

In this second embodiment, the security system utilises the Zygote process to configure an embedded monitoring entity, such as an embedded process monitor method or function, within each newly launched process. During or at some time after launch of the each new process, its embedded monitoring entity is loaded or configured with the security policy associated with the application in the application layer to which the process in the Linux layer corresponds. In this embodiment, the security system enables the embedded monitoring entity to detect and intercept dynamically linked symbols invocations made by their processes using an FCI mechanism or configuration. As will be explained in further detail later, the FCI mechanism intercepts dynamically linked symbols invocations (which may be intended to invoke one or more system calls in the kernel mode of the Linux layer) directed to the a shared object library in the user mode of the Linux layer and redirects those to the embedded monitoring entity within the process. The embedded monitoring entity processes the function call corresponding to the detected symbol invocation and implements a security action based on the security policy configured for the process. As with the first embodiment security system, the security action may vary from: allowing the function call to proceed, modifying the function call in any of its parameters and/or returned values, or halting the function call for example, all of which will have a corresponding effect on any eventual system call executed or invoked in the kernel mode or any other side effect.

Referring to FIG. 8, the general configuration of the FCI mechanism for the second embodiment security system 300 will be explained. In this embodiment, the security system is configured with a set of proxy functions (proxy functions library) 302. The proxy functions library may be a shared library that is dynamically linked to each process, such that each process can be considered as having its own proxy functions library, which in this embodiment is in the form of a Proxy Offset Table (POT) as will be explained later. When a process 304 invokes a function call 306, instead of going directly to the shared library 308 as previously described with reference to FIG. 2, the dynamically linked symbol invocation 306 is intercepted by the proxy functions library 302. This proxy functions library 302 or interception module provides a customised version of the dynamically linked symbols that redirect the invocation or function call to the monitoring entity 310 associated with the process 304 as shown at 312. This customised versions of the dynamically linked symbols have exactly the same signature (and may have the same name) as the actual symbol they are intended to intercept.

FIG. 8 shows a monitoring entity 310 as a separate module to its associated process 304 for clarity, however in this second embodiment, the monitoring entity 310 is an embedded method or function provided or operating within the process 304. Based on the security policy or policies configured in the monitoring entity 310 for the process 304, the monitoring entity 310 implements a security action or decision on the detected function call. By way of example, the monitoring entity may allow, deny or modify the execution of the function call, or kill the monitored process 304 making the function call altogether. If the execution is allowed (in its original or a modified form), then the monitoring entity forwards the actual function call invocation (in its original or modified form) to the actual shared object library that contains the original symbol 308 as shown at 314. After this, the execution of the function and any system calls it may internally invoke is performed as usual with the shared object library 308 performing the actual invocation on the system call gateway 316 as shown at 318, and as previously described with reference to FIG. 2. If the execution is denied, the monitoring entity will disable the invocation of the symbol to prevent the function call executing, and may optionally execute other additional security actions, depending on the nature of the associated system call that was to be invoked and/or security policy associated with the process, such as kill the entire process or return a value or error code to the process to prevent crashing as previously discussed in relation to the first embodiment security system.

The above FCI mechanism may be implemented in various forms. In particular, various methods may be utilised to redirect the execution path of function calls from the actual shared library 308 to the new proxy functions library 302 created by the security system without modifying the Android operating system and the application code associated with applications in the application layer. Various forms of implementing an FCI configuration to redirect the execution path to the proxy functions library 302 will now be described in further detail.

First Form—LD_PRELOAD Variable

In a first form, the second embodiment security system, the FCI mechanism is implemented using the LD_PRELOAD environment variable. The LD_PRELOAD is an environment variable that is used by the runtime linker and can be used for linking user-specified shared objects before other libraries during an executable load stage. In this first form, the security system can configure the LD_PRELOAD variable to tell the runtime linker to link the proxy functions library 302 when a new process 304 is launched.

In this form, the LD_PRELOAD approach is only effective when a process is being launched. Once in execution, if the process loads new symbols from any shared object, the LD_PRELOAD settings will not affect the newly loaded symbols. In particular, the loaded code from a shared object can invoke function calls directly to the shared object library 308 bypassing the proxy functions library 302.

Second Form—PLT/GOT Interposition

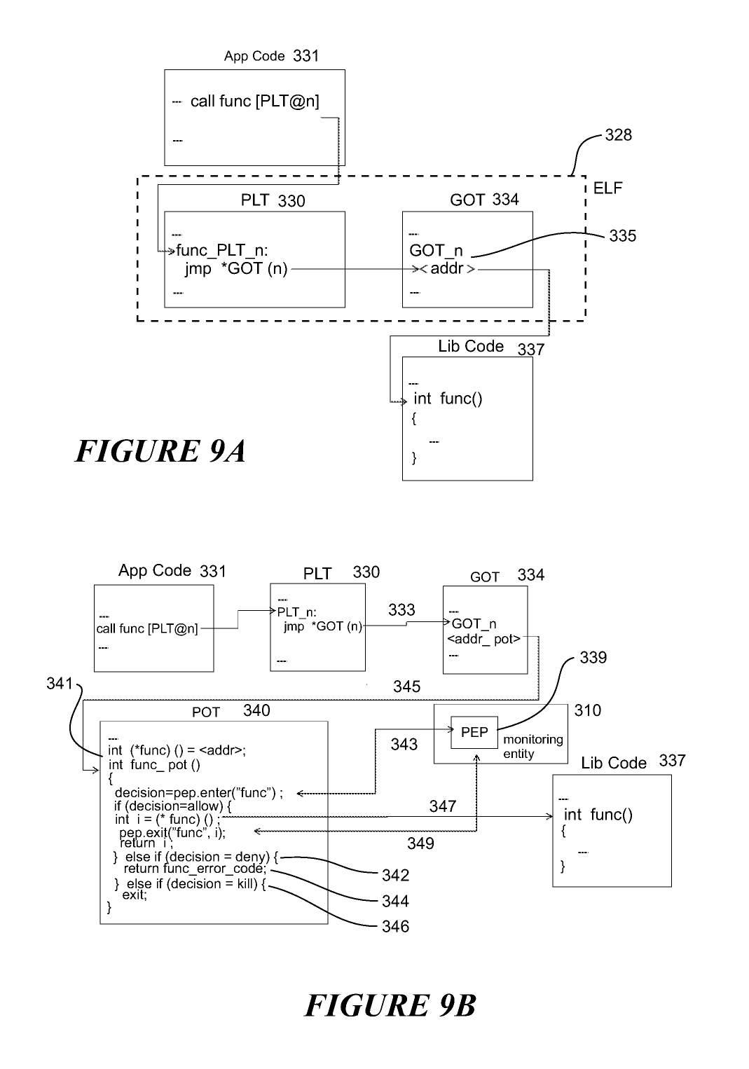

In a second form, the second embodiment security system may implement an FCI mechanism by employing a PLT/GOT interposition. The second form will be described in further detail with reference to FIGS. 9A and 9B.

In Android, all binaries compiled with the standard NDK toolchain, and in particular, the binary in charge of launching the Zygote mother process (/system/bin/app_process) are linked against the Bionic libc library 308 (shown in FIG. 8). This library, in contrast to a normal Linux distribution, is dynamically linked and its code, once loaded in memory is shared by all the running applications. Referring to FIG. 9A, the PLT/GOT indirection mechanism will be described further. A shared object (or shared library) is a special type of file which structure is defined by the Executable and Linkable Format (ELF) 328. During execution, invocations by application code 331 to the symbols provided by shared objects are translated to jump instructions to entries inside the procedure linkage table (PLT)330, a data structure defined as part of ELF specification. The entries of this PLT 330 are stub functions that when invoked perform a jump instruction 333 into entries within a global offset table (GOT) 334, (also defined by the ELF specification). Finally, the entries in the GOT 334 are the real addresses 335 of the target symbols in the shared object's code 337 loaded in memory where the actual symbols reside.

In the second form, the second embodiment security system 300 is configured to implement an FCI mechanism by modifying the PLT/GOT indirection mechanism described as shown in FIG. 9B. In the second form, the security system is configured to re-write the entries in the GOT to point function invocations to a new Proxy Offset Table (POT) 340. Each entry in the 340 points to the embedded monitoring entity 310 embedded in the process and invokes a Policy Enforcement Point (PEP) 339 inside the monitoring entity 310. The monitoring entity 310 will then analyze the symbol being invoked against the security policies configured for the process and implement a security action. If the monitoring entity 310 allows the symbol invocation, the actual symbol 337 will be invoked by the monitoring entity itself

In this embodiment, the security system is configured to modify the GOT 334 entries by changing the original address in the GOT with an address pointing to the wrapper function 345 in the POT 340. The original address is stored in the POT 340 as a function pointer 341. The function pointer 341 has the same signature as the original function: it does not take any argument and returns an integer. The entry in the POT that will be invoked from the GOT 334 also has the same signature as the original function. When the application 331 invokes this function func, the wrapper function in the POT 340 will execute the following steps. First it will invoke the PEP 339 method enter 343 in the monitoring entity 310. This enter method informs the PEP 339 that the application 331 is going to execute the invocation of the function func (note that the invocation is not executed yet). The PEP 339 will take the name of the function and the function parameters (in this example func does not take any parameters). The PEP 339 will pass this information to the other modules in the monitoring entity 310 to decide on a security action.

After the evaluation of the policies inside or accessed by the monitoring entity, if the PEP 339 returns 343 ‘allow’ then the function func can be executed 347. In this example, the function func returns an integer. After the function returns, the security system is configured to perform a second check after the function has completed its execution and returned its value. This enables the monitoring entity to check and modify the returned value of the function, if required by the security policy set for the application 331 invoking the function. For example, the monitoring entity may remove some sensitive information or data, or modify the returned value or values with fake ones. This second check is performed by invoking the PEP method exit 349 inside the monitoring entity 310 and providing as an argument the value returned by the function.

The enter method of the PEP 339 can also return a ‘deny’ value 342, if the security policy dictates that the application 331 should not be allowed to invoke the function func. In this case, a function specific error code 344 is returned to the application 331. Alternatively, the enter method of the PEP 339 can return a decision to ‘kill’ 346 the application. In this case, the wrapper function 345 will perform an exit terminating the process and its application.

The way in which the GOT is populated depends on the compilation settings of the program, i.e. operating system and/or applications. By the default, the GOT entries are populated using a lazy load approach. The first time a process invokes a dynamically linked symbol the actual address of the function is resolved and inserted in the GOT. This means that the memory pages of the GOT need to be modifiable at runtime. Another option is the Relocation Read Only (RELRO). This option specifies that the runtime linker has to resolve all the dependencies in the GOT during the loading time of the process. This option still includes modifying the GOT memory pages during runtime, although these modifications are only done at loading time. Finally, there is the FULL RELRO option that perform the same operations as the RELRO, but once the GOT is populated the memory pages as set as read only. This means that only the process itself can change these entries. By way of example, Android Jelly Bean (version 4.1) Google utilises the FULL RELRO option for compiling Android and system applications code.

In the second form, the POT 340 represents the proxy functions library 302 which intercepts and redirects dynamically linked symbol invocations from its associated process to the embedded monitoring entity 310. In one example, the security system is configured to inject code that modifies the GOT entries in each newly launched process. As the monitoring entity is running within the same process, by using the system call mprotect( ), the security system can set the memory pages of the GOT 334 as writable, perform the modifications and then execute the mprotect( ) system call to set back the permissions to read-only as used in FULL RELRO.

In another example, the security system may utilise Libhijack, which is a C library, to inject the code for modifying the GOT entries into each new relaunched process during execution time. In particular, the security system may utilise Libhijack to modify the GOT entries of a target process to redirect the function calls. Libhijack makes use of the ptrace system call for modifying the memory pages of a target process. However as Libhijack is based on ptrace, it cannot be used when the FULL RELRO option is used, such as in Android Jelly Bean.

Third Form—Hybrid FCI Mechanism Combining LD_PRELOAD Variable and PLT/GOT Interposition

In a third form, the security system implements a hybrid approach combining the simplicity of the LD_PRELOAD with the robustness of the PLT/GOT injection to implement the FCI mechanism. In this third form, the security system utilises the mother process, Zygote, to configure and implement the FCI mechanism as further explained below.

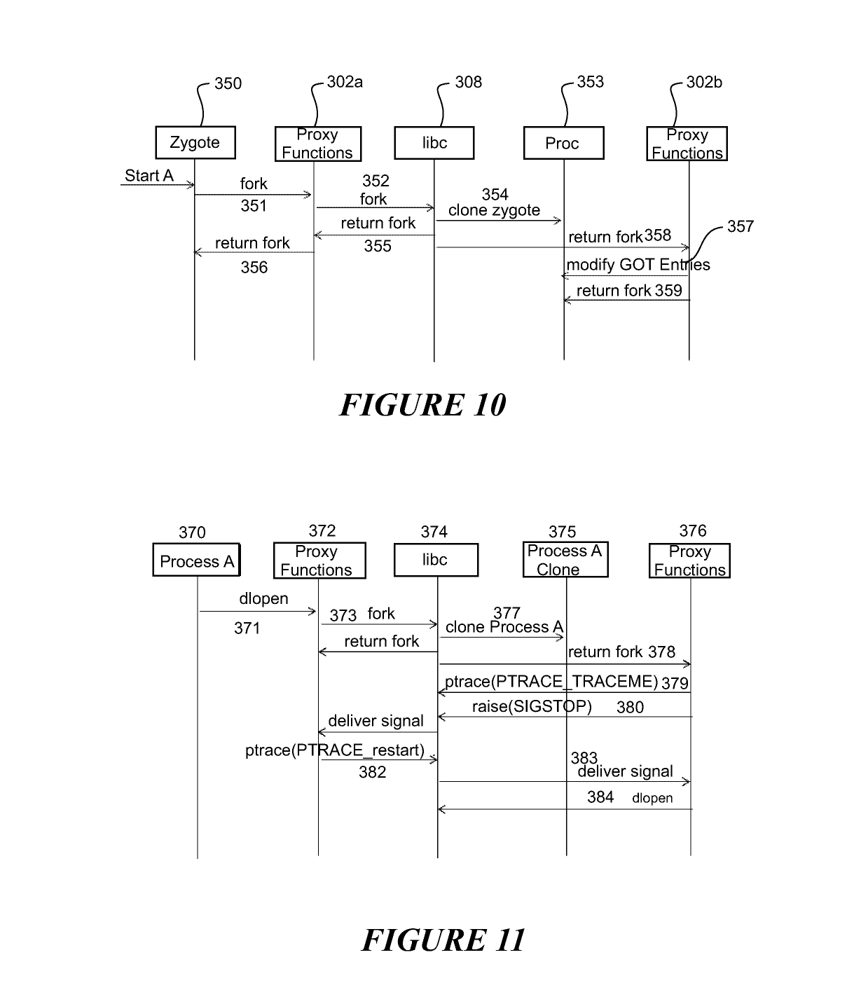

Referring to FIG. 10, firstly, the init.rc file is modified to set a value of LD_PRELOAD for the mother Zygote process to point to the Proxy Functions library 302a. As the security system is initially only interested in monitoring Zygote's invocations to the fork( ) system call, the security system creates one single proxy function for fork( ) in the Zygote process. When a process is forked 351 from Zygote 350, the fork proxy function, with the same signature and name as the original fork( ) function, placed in the Proxy Functions library 302a will be called. This modified fork proxy function will just forward 352 the invocation to the real fork function in the libc library 308 to spawn a new child process 353. When the child process 353 is created it will be an exact copy or clone 354 of the parent process, that is Zygote 350. This means that also Zygote's libraries will be copied in the new child process 353. In particular, the modified LD_PRELOAD setting will be valid also for the child process such that it points to its own proxy functions library 302b. When the kernel 308 completes the fork, it returns a value to both the parent Zygote 350 and child processes 353. However, before returning to the actual processes, the libc library 308 will go through the proxy functions libraries 302a, 302b of both processes. The fork( ) proxy function 302a for the Zygote process 350 will just return 355, 356 without any modifications. However, the proxy function library 302b of the child process 353 will perform the modifications of the GOT entries 357 using the mprotect( ) system call approach described above, before returning 358, 359. From now own, any function call executed by the child process 353 will be intercepted by the modified GOT entries.

When the new process 353 specializes as the intended application, the embedded process monitor method (monitoring entity) will link or load the appropriate security policies for the application. As previously noted, the monitoring entity is embedded or part of the same process that it is monitoring, in contrast to the first embodiment security system where the process monitor is a separate process attached to its target process. In this second embodiment, the embedded process monitor method has access to the package name of the application that the new process is specializing as, and therefore can retrieve the appropriate security policies in a manner similar to that previously described with reference to the first embodiment security system.

In this form, the main advantage of implementing the FCI mechanism for the new child process 353 through the PLT/GOT modifications is that even if the child process loads external libraries as shared objects the PLT/GOT modifications will be still effective. The same cannot be said for using LD_PRELOAD only, as in the first form. Because the system is only interested in intercepting the fork( ) symbol invocation from the main Zygote executable code (but not from other shared objects used by it) using the LD_PRELOAD FCI mechanism is adequate.

If the new process 353 invokes a fork to start a new child process, all the GOT modifications will be copied in the child process memory. Thus the child process will have an embedded FCI mechanism with its own proxy functions library and will be monitored as well by its own embedded process monitor method.

Deployment of Third Form Hybrid FCI Mechanism

To deploy the security system in Android, the security system code will be compiled in a security system shared object. The shared object will be deployed in the /system/lib or /vendor/lib that are the standard folders where libraries are located in Android. Alternatively, the security system code could be deployed in any other folder.

To enable the security system, the init.rc file is changed to set the environment variable LD_PRELOAD to point to the security system shared object. When Zygote is started at booting time, the runtime linker will load the security system shared object before any other libraries. In this way, when Zygote executes a fork, the proxy function for the fork( ) symbol will be invoked instead of the actual fork( ) provided by the Bionic libc.

Security Considerations

There are several security considerations to discuss that arise from using the third form FCI hybrid mechanism.

First of all, with this approach the security system code will be part of the target process image. As such, the target process might execute code to modify the GOT entries to point to the original memory addresses, bypassing the monitoring entity. To avoid this issue, once the GOT entries have been modified, the security system makes the memory page of the GOT entries read-only by means of the mprotect( ) function call. This means that in the case that the target process wants to change the GOT entries, first it has to call the mprotect( ) function call to make the memory pages writable. However, the security system can be configured to intercept this call (through its mprotect proxy function in the proxy function library) and deny its execution via the embedded monitoring entity. As an example, the execution may be denied if the security system detects the process is trying to unprotect memory pages that belong to the GOT.

Code used from statically linked libraries is included as part of the text region of the binary, which means that it will not be under the control of the security system, using the approach provided by this embodiment. However, this approach assumes that all code that has been statically linked is trusted code. The security system's main concern are those shared objects that may be loaded in runtime.

System calls can be invoked by means of syscall( ) function call providing the system call number followed by the necessary parameters. This can bypass the security system for such system calls. In order to avoid this, the security system can be configured to intercept the syscall( ) library function and retrieve the system call number corresponding to the system call that the process wants to execute. Instead of using the system call from the original library, the monitor can redirect the execution to the proxy function corresponding to such system call.

The function dlsym( ) takes a handle of a dynamic library returned by dlopen( ) and a symbol name string as parameters, and returns the address where that symbol is loaded into memory. As a special pseudo-handle, the RTLD_NEXT constant can be passed to it in order to find the next occurrence of a function in the search order after the current library. This means that the modification of the entries in the GOT have to be done in a recursive way. This also applies in the case where a shared object makes use of a second shared object. To be able to intercept the function call from the second shared object we have to perform a recursive injection to avoid this issue.

Dynamic Switch to SCI Mechanism—Ptrace

There are cases in which is still possible to bypass the third form hybrid FCI mechanism.

For instance, the process might want to load by means of the dlopen function call untrusted symbols from a random shared object. The modifications of the GOT entries will not be valid for this code as the program's binary hasn't been linked against such shared object, so there are no entries in the PLT/GOT for such symbol.

Another issue is with in-line assembly code that allows applications to bypass libc library in order to invoke system calls through machine code. In this case, the code is put by the compiler within the binary's text region, and no library calls are invoked, as the machine code that invokes the system call is put there at compilation time. This means that the security system can be bypassed using this mechanism.

However, the security system can be configured to detect the above behaviour. For the case of the dlopen function call, the process has to invoke the symbol, which is provided by libdl.so, and linked dynamically. The security system provides a proxy function for this symbol what means that it can control which shared objects are loaded in runtime. For the in-line assembly code issue, the security system can be configured to parse untrusted native code to detect the instruction that generates the hardware interruption to change into supervisor mode (SWI #0 on ARM).

In both the above cases, the security system can dynamically switch to the use of an SCI mechanism such as ptrace( ) as it is done for the first embodiment security system. By way of example with reference to FIG. 11, when a process 370 invokes the dlopen function call 371, the security system intercepts the function call with the dlopen proxy function in its proxy function library 372. The dlopen proxy function will be configured to fork a new process that is an exact clone 377 of the running process 370 including the proxy functions library 376.

When the fork returns 378 on the cloned process 376, the cloned proxy function library 376 will disable the proxy functions library and invoke the ptrace system call 379 with the option PTRACE _TRACEME. This option tells the kernel that the child process 375 wants to be monitored by another process 370. The child process 375 also raises a SIGSTOP 380 to be stopped until the parent process 370 allows it to resume its execution. When the child process 375 resumes its execution, it will continue with the dlopen 384 operation and the shared object (new native code) will be loaded within its image so that its symbols will be accessible to the process.

On the other hand, the monitoring parent process will also disable the proxy functions library 372 and by invoking ptrace with the option PTRACE _SYSCALL 382 will deliver a signal 383 for letting the new process 375 continue its execution until its next system call.

The monitoring entity in the parent process can then execute a security action regarding the intercepted system calls based on the security policy associated with the parent process. In other words, the parent process 370 it attached to the child process 375 such that it is configured to monitor system calls made by its target child process 375 via ptrace as in the first embodiment security system.

When the shared object is unloaded, the clone process 375 can be killed and the execution of the main parent process 370 will be resumed as before with the FCI mechanism of the proxy functions intercepting the function calls. For example, the monitoring entity can be configured to detect the call to dlclose to be notified that the shared object is unloaded.

### 4. Timed (Late/Delayed/Lazy) Security Policy Binding

Overview

Loading or linking security policies from a security policy database or policy configuration source to the monitoring entity attached to or embedded within a new process corresponding to a newly launched application involves obtaining information to correctly identify the application that such process has specialized as.

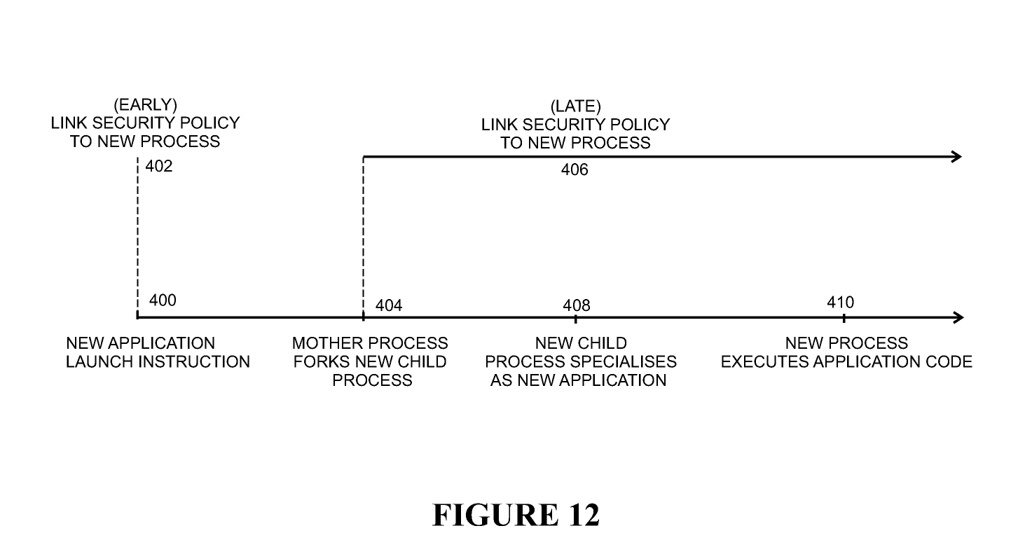

As previously discussed, in conventional Unix and Linux operating systems, security systems have been proposed that link security policies to new processes immediately based on launch information directly available to them from the shell command line, which contains as an argument the application name of the newly launched application. Referring to FIG. 12, such security systems link or retrieve the application identification data necessary to link the security policy or policies to the new process at 402, based on the initial launch instruction 400, e.g. the shell command line arguments. This early security policy binding mechanism means that security policies are associated with the new launched application before the actual application code of the new process even starts to specialize. The main issue with this approach is that a malicious application might fool the system by late specialization into a different application than the one used in the shell arguments: as a result, the wrong set of security policies might be associated to the new process.

Referring to FIG. 12, the security system in at least some embodiments uses a late security policy binding mechanism, in which the linking or association of a security policy or policies to a newly launched process is timed or delayed until a predefined identification threshold is reached or a predefined event has occurred, such as at least until on or after the new process is forked 404 by the mother process as shown at 406. For example, the application identification data (which is used to link or associate the correct security policy or policies) corresponding to the application or type of application that the new process is specializing as is not determined or extracted until on or after the new process is forked 404. In this description, the phrase “linking” or “associating” a security policy with a process is intended to mean the extraction of the application identification data (e.g. application name, signature or package name) of the application in the application layer to which the new process will specialize as such that the security policy or policies are determined based on that application identification data, and/or the actual configuring or loading of the security policy or policy into the monitoring entity attached to or embedded into the new process.

In one form, the security policy is linked on or soon after the new child process has been forked 404. In another form, the security policy is linked as the new child process is specializing 408, or once the new process has specialized, with the application code. In another form, the security policy is linked on or after the new process begins executing 410 the loaded application code after specialization. In another form, the security policy is linked only when a predefined identification threshold is reached that corresponds to collecting or receiving enough or sufficient data or evidence indicating or confirming that the new process launched in the Linux layer corresponds to the application in the application layer the user intended to launch.

The above late security policy binding mechanism may be applied or implemented to either of the first or second embodiment security systems described above in the context of the Android operating system. Additionally, this late policy binding mechanism may be applied to other operating systems, including Linux or Unix operating systems, iOS, or any other operating system that launches new processes with a mother process, as will be explained further below by way of example only.

The late security policy binding mechanism may be implemented in the context of the security systems described in the first or second embodiments, or in the context of any other operating system security system in which it is necessary to associate an application-specific or application-type specific security policy or policies with a newly launched process executing the application.

Android Operating System

As previously explained for the first embodiment security system, the application identification data (e.g. the full application package name) is retrieved during the final step of the specialization process of the new forked child process. In particular, as the security system is configured to rely on the last step executed by the child process specializing 408 into an application when it sets its application name into the specialization data file, e,g, within the /proc filesystem. When the application has specialized, it will set its name into the /proc/self/cmdline file after the prctl system call exits. This occurs after the process is forked 404 and before the new process begins executing 410 the actual application code.

Other methods for extracting or identifying the application or type of application a process has or is specializing as may also be used, and some other examples will be explained in further detail later.

Linux Operating System

The late security policy binding mechanism may also be used when the security system is deployed or implemented on a Linux operating system. In Linux, the /proc filesystem is used for maintaining information about the running processes (as in Android). As with Android, after the process has specialized, the application identification data relating to the newly launched process is set in the /proc filesystem, and can be retrieved to enable the appropriate security policy or policies to be linked to the new process.

iOS—Mobile Operating System

The security system described can also be deployed on the iOS platform. The main requirements for the first embodiment security system to work on iOS is: (i) a System Call Interposition mechanism such as ptrace or similar for tracing process execution; and (ii) a mechanism for attaching process monitors to the processes.

As iOS is a Linux-based OS, the ptrace tool is present. However, in iOS ptrace is frequently used by application developers to deny debuggers to attach to their applications. The ptrace option PT_DENY_ATTACH. This option is a protection mechanism to avoid attaching to processes. This means that no other processes are able to attach to the process that uses this option in its code. To bypass this restriction and be able to attach to a process (even if it is protected by the PT_DENY_ATTACH option) there are several solutions.

It is also possible to attach a process monitor to an application process in iOS. Applications in iOS are written in Objective-C, a superset of C. As with all C programs, Objective-C programs start with a main method. This main method is automatically created for all applications in iOS and it is placed in a separate main.m file in the Supporting Files group. All the applications have the same main method. Each main method calls the UIApplicationMain method, which is responsible for loading the class specific to the application that is being launched.

In order to attach to a process monitor to a new process, the security system is configured to modify the main method of each application installed on the device running the iOS. In particular, the security system is configured to modify the iOS to launch the main monitor of the security system first and then the main monitor will launch each application using UIApplicationMain. The modification of the main method code is automated. The security system is provided with a script that deploys the security system through an application and this causes all the main.m files to be modified. Additionally, the script is configured to modify the main.m file of any applications downloaded onto the device after the security system has been installed.

The main.m file is compiled code, and there are various ways in which it can be modified or replaced with a modified version. Alternatively, the security system may be configured to patch the executable of the application using the otool to disassemble the binary main.m code and then patch it with the necessary ARM code to insert the call to the main monitor code of the security system.

Once the security system is installed such that a process monitor is able to attach to and monitor an application, the late security policy binding mechanism can be used to link a security policy or policies to the application. iOS is based on Unix and it uses its own version of the /proc filesystem. However, to access the application identification data or information contained in the /proc filesystem, the sysctl special system call may be used. This system call retrieves information on the kernel state including the name of the running processes. Using the sysctl system call, the security system can wait until the process name is set (by this time sysctl will be able to retrieve it) and load or link the security policies to the process.

Unix-Based Systems Generally

In general, the late security policy binding mechanism can be applied to any Unix-based systems (including Android, Linux and iOS as noted above) where a new process is created and its specialization application package name is set in a separate location accessible directly (as for /proc in Android and Linux for example) or indirectly (as for sysctl in iOS for example) by the process monitor attached or embedded in the process. This is because in Unix-based systems when a process is launched, it is forked from a parent process. For example, in the case of the Linux OS there is a special process called init, which is responsible for starting any new process through the command shell. When the security system is deployed in Linux, a main monitor may be attached to init and any time a new process is forked, a new process monitor will be attached. The security policy to be linked to the new process and enforced on the process monitored is then determined using the late security policy binding mechanism.

Examples of Process Specialization

In Unix/Linux operating systems, the creation 404 of a process is separated from its specialization 408, as shown in FIG. 12. The creation of a process is performed by means of a fork system call. When a process calls fork a child process that is the exact copy of the parent process is created 404. The two processes will continue execution independently from each other. However, each process has to know whether it is the child or the parent process. This can be done by the value that is returned by the fork. In the parent process, the fork returns the Process ID (PID) of the newly created child process. In the child process, the fork returns 0. Because PID 0 is not assigned to any process, the child process knows that it is the child and that it has to specialize.

In Android, processes are created in a way similar to Unix/Linux. However, the way in which they specialize is different. In Unix/Linux the child process specializes by means of calling one of the system calls from the exec family. When a process calls the exec system call, the process ceases executing its current program and begins executing a new program from its beginning. The exec system call uses the name of the program and the parameters to be passed to the program as arguments. There are several ways in which a child process gets the application name of the program to execute or specialize as, as further explained below.

Retrieving Application Name Hard-Coded into Parent Process

In one example, the program name is already hardcoded in the parent process code. After the fork of the new child process, the child process will use the name for executing it through a execvp system call. In this example, the application identification data can be extracted directly from the child process code after forking.

Retrieving Application Name from a File

In another example, the parent process can also retrieve the program name from outside its code. For instance, it could read it from a file. In this example, the application identification data can be extracted directly from such a file.

Retrieving Application Name from External Process Communicating with Parent Process.

In another example, the parent process could receive commands from an external process using an Inter Process Communication (IPC) channel, such as a socket like a Unix socket. In this case, the client socket is opened in the parent branch of the fork. When the parent receives the program name through the socket, it forks the child process. When forking, the program name will be contained in the child memory since it is still a copy of the parent process.

Retrieving Application Name Pushed to Child Process by an External Process

In another example, the child process may be configured to open an IPC channel and waits for the program name to be provided through that IPC channel. By way of example only, the child process may use a socket to listen for program names. In this example, the program name is pushed to the child. In this case, the client socket is opened in the child branch of the fork.

Retrieving Application Name Pulled by Child Process from Another Process

In another example, the child process may be configured to establish an IPC channel with another process. In this example, the child process may be configured to send a request for pulling the program name from the other process. In this case, the client socket will be opened in the child branch of the fork.

Android—Application Name Retrieval

In Android, applications are usually Java programs compiled into bytecode which executed in a Dalvik Virtual Machine and optionally can execute native code placed in shared objects through the Java Native Interface (JNI). The Zygote process is the only process that can create new applications. Zygote receives from internal Unix socket the commands to fork new applications. The command contains the name of a Java class name that will be loaded in the child process' virtual machine using Java Reflection. The class provides the static main method of the application to be run. However, the class name does not represent the package name of the application. This information will be retrieved from the manifest file of the application and then set in the /proc filesystem using the prctl system call as previously explained.

Linking Security Policy During Process Execution

The various examples demonstrate how an application-specific security policy may be linked with a newly launched process after forking of the new process and during specialization of the process as the application, using a late security policy binding mechanism.

In other forms, the late security policy binding mechanism may delay linking a security policy until after the process has specialized, and once it is executing the application code. In this example, the late security policy binding mechanism is configured to monitor the execution of the application code, characterise the type of application that is executing, and link a security policy or policies appropriate to that determined application type. By way of example, the security system may characterise the type of application based on various process actions, including but not limited to:
What hardware resources the process is attempting to access, e.g. camera, network, storage, memory, GPS sensors, microphone.
What data the process is trying to access and/or modifying, e.g. SMS, emails, account information, pictures, videos, passwords.
What other processes it is trying to communicate with: accessing other applications in the device, requesting accesses to sensitive services such as the dialer or the SMS sending service.

The security system may block the process from executing any prohibited actions until the characterization is complete, and the security policy linked. Once the security policy is linked to its process monitor, the process is allowed to continue with normal execution to the extent allowed by its process monitor based on the security policy.

### 5. Device Hardware Configuration and Installation of the Security System

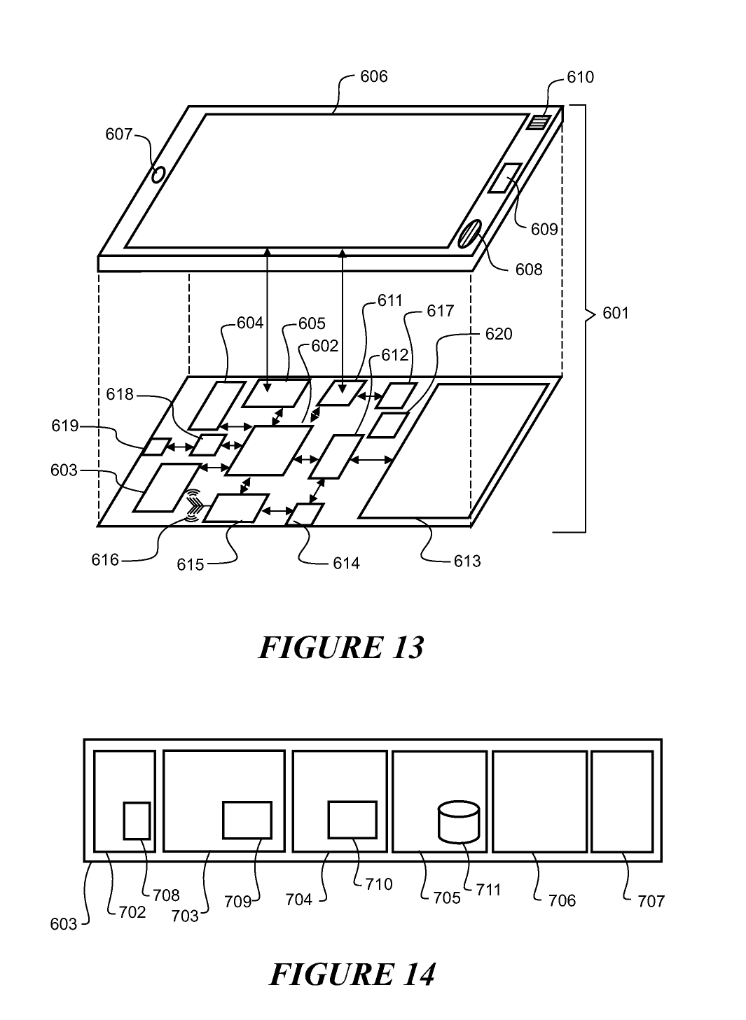

As set out above, the embodiments of the security system may be implemented on any suitable hardware device or system running the Android OS or Linux-based OS, or similar. With reference to FIGS. 13 and 14, an example of the hardware componentry of a typical smartphone or tablet device upon which the security system may run will be described, and the security system installation process.

Referring to FIG. 13, typically a device 601 such as a smartphone or tablet contains the following components: a processor 602 that executes instructions that are either stored in a permanent storage device 603 and/or in volatile memory 603. Images, video and other multimedia output from the processor can be displayed using a monitor/display/touchscreen 606. Display data for the display 606 is prepared by the graphics device/touchscreen controller 605 which may be embedded in the processor 602. A user can operate the device through the touch screen 605 or buttons 609. Such instructions can be fed back to the processor 602, optionally through a controller device 605. Sound can be outputted through loudspeakers 608 which may be provided with a signal through an I/O interface 610 that may be embedded in the processor 602. Optionally, the touchscreen 606 may be provide haptic feedback, controlled by the I/O 610 interface to the user. Optionally, the device is shaken or rumbled to alert the user with the rumble/shaking device 620 controlled by the I/O 610 interface. The device may be equipped with several sensors to record sound using microphones 610 and images or video using cameras 611. There can also be position (such as Global Position System receivers), acceleration (accelerometers), orientation (tilt & gyroscopes) and environmental (temperature, light, radiation, moisture, gas, pressure) sensors 617. The device and all its components are powered by a battery 613. Alternatively the device could be powered through a wired interface 614. Power is regulated and distributed by a power management system 612. The battery can be charged through a wired 614 or wireless 612 interface.

To connect to the outside world and communicate data the device can use either a wired 614 or other (wireless) connectivity 615. The (wireless) connectivity 615 may be radio or light based communication. An antenna is used to transmit and receive radio signals for wireless communication 616. This antenna may or may not be embedded in the device. The wired or wireless connection may provide networking capabilities. For telecommunications subscription information the device may use a Subscriber Identity Module 619, which may be a card inserted into the device. The Subscriber Identity Module 619 may interface with the processor 602 through a controller 618.

An Operating System, such as Android, can be used to let the user control both hardware and software in the device. The operating system is software including a set of instructions for the processor 602 that is normally installed on the permanent storage device 603. When the device is operating the Operating System may also be placed, in part, in the volatile memory 604.

Malicious software or code (instructions) may be placed on the device storage locations 603,604 by a (unaware) user or another party through the wired interface 614 or wireless connectivity 615,616. It can trick the Operating System in letting the processor 602 perform instructions for malicious purposes. To prevent the processor 602 from carrying out malicious instructions the security system described in the previous embodiments is installed on the device and will interact with the operating system. The security system is typically installed on the device storage locations 603,604.

Referring to FIG. 14, an example of how the security system is installed on the storage device 603 will be explained. Typically, a storage device 603 with an Operating System (O.S.), such as Android, installed contains the following partitions: boot 702, system 703, recovery 704, data 705, cache 706 and miscellaneous (misc.) 707.

### First Embodiment Security System Installation

In order to deploy the security system using the first embodiment the following modules should be modified. The main monitor binary should be placed into the device's boot 702 partition. Also, the init.rc 708 file, which is part of the boot 702 partition should be modified in order to modify the “zygote” service, which should point to the monitor binary location. In order to modify the device's original boot 702 partition, the partition image should be pulled out from the device. In a second stage, the binary file should be unpacked, resulting in the kernel image and the bootloader image. The bootloader image should then be patched by copying the main monitor binary into it (typically in the /sbin folder) and modifying the init.rc 708 file to update the “zygote” service. Once patched, the bootloader can be repacked along with the kernel image to generate a patched version of the boot 702 partition, which should be pushed back into the physical device.

The security system service should be place into the system 703 partition. In order to do so, the system 703 partition should be remounted with write permissions, so that the service package file can be copied into it (typically into the /system/app). Once copied, the partition can be remounted back to its readonly state. Optionally, the monitor binary may be also installed within the system 703 partition (typically within /system/bin). Optionally, a backup of the security system and/or local policy configuration file (or policy database) may be stored in the recovery partition 704. In case of installing a local policy configuration file (or policy database), it will be placed in the data 705 partition (typically within /data/system), along with any other data files that the security system might need to use (this may include a copy of all system components to re-enable the framework after OS actualizations).

Once all components have been deployed into the device, it should be restarted to finalize the process. Once the device has rebooted, the security system is up and running.

### Second Embodiment Security System Installation

In order to deploy the security system using the second embodiment the following modules should be modified. The init.rc 708 file, which is part of the boot 702 partition should be modified in order to modify the “zygote” service, which should environment should be set so that LD_PRELOAD point to the proxy function library location. In order to modify the device's original boot 702 partition, the partition image should be pulled out from the device. In a second stage, the binary file should be unpacked, resulting in the kernel image and the bootloader image. The bootloader image should then be patched by modifying the init.rc 708 file to update the “zygote” service. Once patched, the bootloader can be repacked along with the kernel image to generate a patched version of the boot 702 partition, which should be pushed back into the physical device.

The security system service should be place into the system 703 partition. In order to do so, the system 703 partition should be remounted with write permissions, so that the service package file can be copied into it (typically into the /system/app). Once copied, the partition can be remounted back to its readonly state. The proxy functions library should also be installed within the system 703 partition (typically within /system/lib). In case of installing a local policy configuration file (or policy database), it will be placed in the data 705 partition (typically within /data/system), along with any other data files that the security system might need to use (this may include a copy of all system components to re-enable the framework after OS actualizations). Optionally, a backup of the security system and/or local policy configuration file (or policy database) may be stored in the recovery partition 704. Once all components have been deployed into the device, it should be restarted to finalize the process. Once the device has rebooted, the security system is up and running.

### 6. Third Embodiment Security System—Google Chrome OS

The embodiments of the security system above may also be adapted/applied to other Linux-based operating systems, such as the Google Chrome operating system (OS). The Chromium Projects include Chromium that is the open-source project behind Google Chrome Browser; and the Chromium OS that is the open-source project behind the Google Chrome OS.

The two projects have a large portion of their code base in common. In particular Chromium OS/Google Chrome OS is a Linux-based operating system that executes solely web-based applications. This OS takes a minimalist approach where the only applications residing in the device are the browser (that is Google Chrome), media player and file system. Essentially, the web-based applications are executed within the browser. Given the common approach (essentially running applications within the browser), in the following discussion we will use the term Chromium to refer to both projects (Chromium and Chromium OS).

The main idea behind Chromium is to run in different processes instances of functionality. With functionality here we refer to code downloaded visiting a web page, executing a web application, and other code that it will be rendered and executed by Chromium processes.

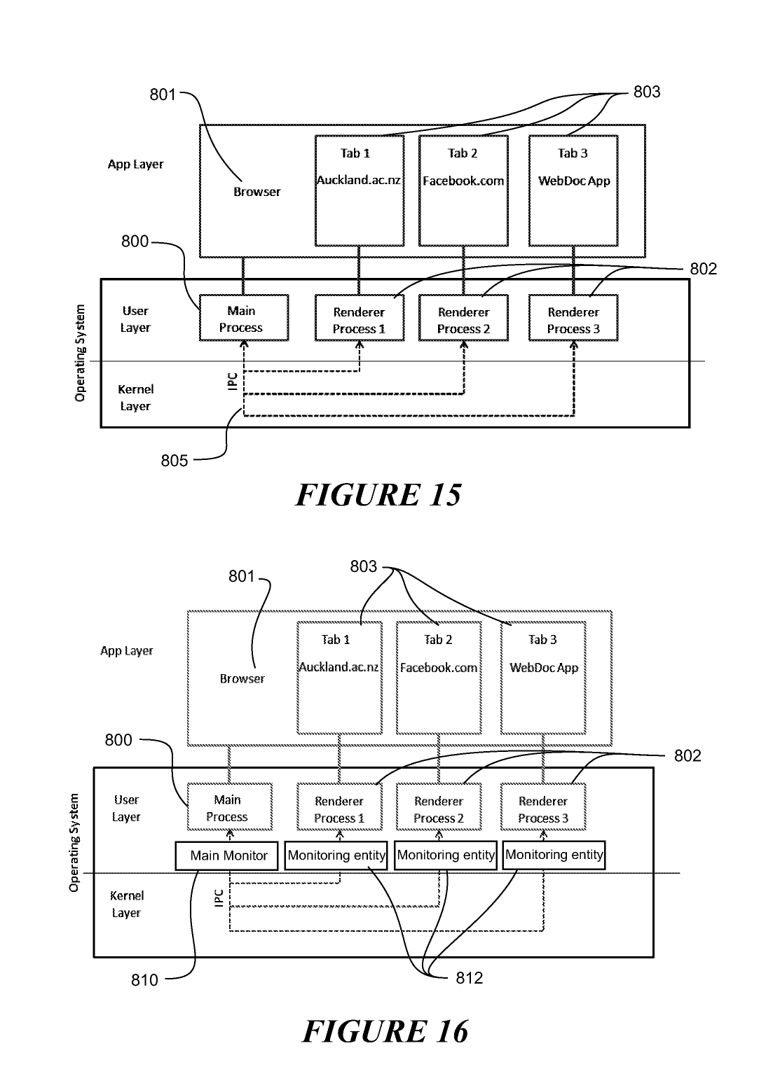

As shown in FIG. 15, Chromium has a main process 800 (called the “browser” 801) responsible for displaying the User Interface (UI) and managing the other processes 802 where tabs and plug-ins are executed. Tab processes are called “renderers” and are responsible for rendering the functionality within each tab using rendering engines such as WebKit and Blink. In this sense the tabs and plug-ins define functionalities for the device running ChromeOS.

By default, Chromium creates a new renderer process 802 for each instance of a website a user visits (process-per-site-instance). A site is defined as a registered domain such as auckland.ac.nz. This means that multiple tabs pointing to the same site will be executed in different processes. Another model is process-per-site where different sites will be run on different processes. However, multiple tabs pointing to the same site will be run by the same process. Process-per-tab is another model where each tab will be rendered by a dedicated process. Finally, Chromium can be executed in a single process.

FIG. 15 shows the case of a different renderer process for each functionality instance. In particular, each of the tabs 803 that is executed within a dedicated renderer process 802 is providing a specific functionality to the user. For instance, Tab 1 visualises the auckland.ac.nz web page, Tab 2 visualises the facebook.com web page, and Tab 3 is executed a web-based app.

Each renderer process 802 executes code to provide the user with some functionality. This functionality may be loading a HTML page or executing a web-based application. From the OS point of view, each process 802 is a child of the main process 800 (browser) and is not aware of the specific functionality provided by each renderer process. However, the OS does not have a direct view of the functionality of each renderer process. In other words, each renderer process is an “opaque” process. Thus, enforcing security policies specific to the functionality of each renderer process is not straightforward.

The loading of a specific functionality within each renderer process 802 is performed by having the renderer asking the main process 800 through Inter Process Communication (IPC) calls 805 to fetch the code from the web. This IPC channel between the main process 800 and all the renderers 802 is established using interfaces offered by the kernel by means of function call and system calls. For instance, the socketpair( ) function/system call is used when Chromium is deployed on Linux and Mac OS X to establish a channel between the main process 800 and the renderer process 802. The security system described in the previous embodiments can be deployed to exploit this communication channel to intercept the messages that specify the functionality loaded in each renderer process and enforce specific security policies as will be explained next.

FIG. 16 shows how the security system monitors or monitoring entities can be attached to different processes within Chromium. Firstly, the main monitor 810 will be attached to or embedded within the main process 800 and will monitor when it will spawn new renderer processes 802. When a new renderer process 802 is spawned, a new process monitor 812 (or monitoring entity) will be attached to the new child process 802, such that each new process has its own respective monitoring entity. Chromium uses the same approach as in Android to spawn new process using a Zygote process that will fork itself to create renderer processes.

Each monitoring entity 812 can intercept the system calls its associated renderer process 802 makes to communicate with the main process 800 and extract information for identifying what functionality each renderer is executing. This allows the security system to associate specific security policies (from a policy database) tailored to the functionality each renderer will execute, i.e. each monitoring entity retrieves and enforces security policies specific to the application corresponding to its process. So for instance, the monitoring entity 812 monitoring the renderer process 1 will enforce security policies specific for the domain Auckland.ac.nz (Tab 1), whereas the monitoring entity 812 monitoring the renderer process 2 will enforce policies specific for the domain Facebook.com (Tab 2). It will be appreciated that the main monitor 800 and process monitors 802 may be either part of (e.g. embedded within) the respective process they are monitoring, in which case the FCI technique is used, or a separate process attached to the respective process they are monitoring, in which case the SCI technique is used, both techniques of which are described in the previous embodiments.

### 7. Analysis System

Overview

An embodiment of the analysis system will now be described with reference to FIGS. 17-21. The analysis system is a profiler and/or analysis tool that is usable by a security expert or system administrator in various modes.

In a one mode, that analysis system can be used to analyse applications executing in runtime to identify malicious/suspicious behaviour. In this mode, the analysis system can be used to profile application execution on a given device image (vendor +OS version), and this profile information can be used to create customised security policies that can be deployed on the profiled device image. In one configuration of this mode, the analysis system operates in a single-step mode in which the execution of the application is stalled or paused after detection of all or a particular set of system call invocations initiated by the application, and the analysis system reports or notifies this detection to the user along with data indicative of the detected system call and awaits a security action decision from the user, i.e. whether to allow or deny the execution or some other security action as previously described in relation to the security system embodiments above, and the analysis system builds a customised security policy based on the decided security actions. The customised security policy can then be deployed to operate on the profiled device or other devices under the administrator's control that are running the same application or sets of applications on devices running the same application.

In another mode, the analysis system can be used to in a policy-debugging mode or logging mode in which the security system is operating on the device to enforce configured security policies against the various executing applications, and the analysis system retrieves data indicative of the application execution as controlled by the enforced security policies for the user to view such that refinements or improvements to the security policies can be made to enhance performance and/or security.

Analysis System Configuration

Referring to FIG. 17, the analysis system comprises modules that are installed on the target device 900 running the applications to be analysed and a module or modules on an analysis device 902 that is in data communication 904 with the device 900 and which provides a graphical user interface (GUI) for the analysis. The modules deployed on the target device 900 profile or retrieve data indicative of the execution of the applications, and the profile information collected is then sent to the modules running on the analysis device for display and user interaction.

The target device 900 may be any electronic device having an operating system that the security system previously described may operate on. In this example, the target device 900 is a smartphone, but it may alternatively be, for example, a tablet, PDA, computer or any other device running an operating system upon which applications execute. The analysis device 902 may be any other electronic device that can communicate with the device 900, such as desktop or laptop PC, or a tablet, PDA, smartphone or any other programmable device having a user interface comprising a display and one or more user input devices, e.g. touch screen, mouse, keyboard, and/or similar. The data communication link between the target device 900 and analysis device 902 may be any suitable wired or wireless data communication link or medium such as, for example, a USB cable that operatively connects the two devices or a wireless data communication link, such as over WiFi or Bluetooth, or any other suitable data connection.

The target device 900 is operating a security system according to either of the first or second embodiments described above. The analysis system is an extension of the security system modules, and in some particular modes the analysis system controls the operation of aspects of the security system temporarily. The analysis system is configured based on the policy-based security system previously described. The security system provides the monitoring infrastructure on the target device, and in circumstances where security policies are already deployed it is also responsible for enforcing the security policies.

By way of example only, the target device 900 is shown running two applications 906a,906b. For clarity, only the respective monitoring entities 908a,908b of the security system associated with each of the applications 906a,906b is shown. The monitoring entities operate as previously described to monitor their respective associated application to intercept and/or detect system call invocations. In particular, the monitoring entities collect details or data indicative of the system call invocations that their associated applications execute as shown at 912. The system call information typically includes the name of the system call and the values of the system call parameters. The analysis system provides profiler modules 910a, 910b, one attached to each respective monitoring entity 908a,908b. The profilers 910a,910b piggyback on the functionality of the monitoring entities 908a,908b of the security system to collect system call information for analysis. The profilers 910a,910b are attached to their respective monitoring entities 908a,908b and access the system call information retrieved by the monitoring entities as shown at 914. In this embodiment, the monitoring entities 908a,908b of the security system are modified to communicate with the profilers 910a,910b of the analysis system. In single-step mode, the monitoring entities communicate directly with their respective profilers, bypassing the Policy enforcement point (PEP) and Policy Deciscion Point (PDP) modules of the security system. In the policy-debugging mode, the monitoring entities first communicate with the PEP and PDP modules to obtain and enforce a security decision in accordance with the previously described security system, and then pass this security decision and system call invocation information to their respective profilers. In either mode, the profilers 910a,910b then forward this information to an analysis agent module 918, for example via an Inter Process Communication (IPC) channel as shown at 916. The agent module 918 maintains or stores the information locally on the target device, and is operable to send the information to the analyser device.

The analysis system provides an analysis GUI module on the analysis device 902 that the user may interact with to carry out the various tasks previously mentioned, depending on what mode of operation the analysis system is running When the analysis GUI of the analysis device 802 connects to the target device over the data communication link 904, the agent 918 streams the received system call information to the analysis GUI over the data communication link for subsequent analysis and interaction by the user on the analyser device 902. For example, system call information is displayed on a display of the analyser device 902 for the user, such as a system administrator. In this embodiment, the data communication link 904 between analysis GUI on the analyser device 902, e.g. PC, and the agent 918 on the target device 900 is via a USB cable and is tunnelled using the port forwarding feature of the Android Debug Bridge (ADB). ADB is a tool provided by the Android SDK. ADB's port forwarding works only in the PC-to-device direction, meaning that the communication can be initiated only by the analyser device. With this configuration, the analysis GUI on the analyser device 902 pulls information from the agent on the target device 900. In alternative wireless data communication link configuration, port forwarding over a Secure Shell (SSH) tunnel via a WiFi connection may be used for example. However, it will be appreciated that in alternative embodiments, the system may be configured to allow either the target or analyser devices to initiate data communication.

IPC Communication Specification—Data Structures

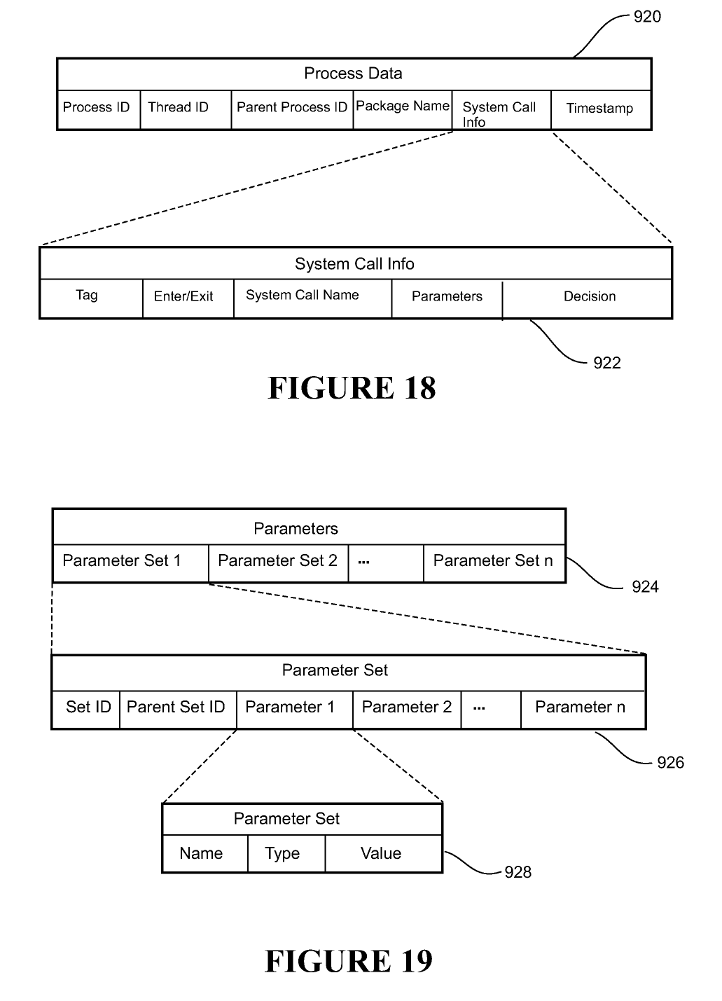

In this embodiment, the communication between the profilers 910a,910b and agent 918 is an IPC. The data structures used in the IPC transactions will now be described with reference to FIGS. 18-20.

Process Data Data Structure

FIG. 18 shows the high-level data structure used in the IPC calls between a profiler and the agent on the target device upon the profiler receiving system call information detected by its associated monitoring entity. The main Process Data data structure 920 contains the information about the process (executing the application) and the thread from the where the detected system call invocation is generated. In this embodiment, the Process Data data structure 920 contains the following fields:
Process ID: the ID of the process executing the system call;
Thread ID: the ID of the thread executing the system call;
Parent Process ID: this represents the ID of the parent of the process executing the system call;
Package Name: the package name of the application executed by the process;
System Call Info: a pointer to a System Call Info data structure 922 with more information about the system call being executed; and
Timestamp: the timestamp is used to order the system calls when they are displayed in the analysis GUI according to the time when they have been captured.

System Call Info Data Structure

In this embodiment, the System Call Info data structure 922 pointed to by the Process Data data structure 920 contains the following fields:
Tag: a unique identifier assigned by the agent before the System Call Info is sent to the anlaysis GUI—and which is explained in further detail later;
Enter/Exit: this field indicates whether the system call is entering or exiting mode;
System Call Name: the name of the system call;
Parameters: a pointer to a Parameters data structure 924 (FIG. 19); and
Security Decision: a pointer to a Security Decision data structure (FIG. 21)—and which is explained in further detail later.

Parameters Data Structure

Referring to FIG. 19, the Parameters data structure 924 for this embodiment will be explained further. Often system calls made by applications have as parameters pointers to complex data structures that might contain pointers to other data structures. To represent such complex argument types, the analyser system utilises a specific set of data structures to deal with such situations. The Parameters data structure 924 contains one or more Parameter Set data structures 926. In this embodiment, each Parameter Set data structure 926 contains the following fields:
Set ID: the ID of the set;
Parent Set ID: the ID of the parent set. This can be 0 in case this parameter does not have a parent; and
Parameter i: this is a pointer to a Parameter data structure 928 representing a parameter of the system call

In this embodiment, each Parameter data structure 928 contains the Name of the parameter, its Type and Value (which could also be a pointer).

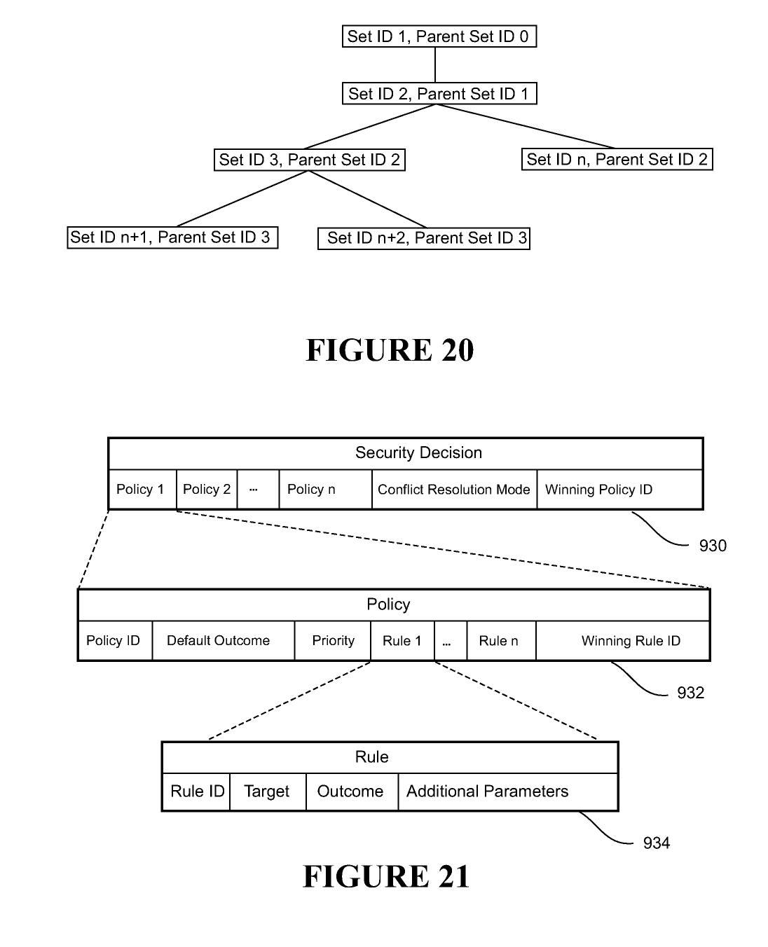

The use of Set ID and Parent Set ID in the Parameter Set data structure 926 allows the analyser system to represent with a linear data structure a multi-level data structure such as a tree. An example of how to represent a tree using the Parameter Set ID and Parent Set ID is shown FIG. 20 by way of example.

Security Decision Data Structure

The monitoring entities of the security system are responsible for monitoring application behaviour by intercepting the system call invocations that processes and threads perform during execution of an application, as previously described with reference to the embodiments of the security system. This is the profile information required by the analysis system to create an application profile, which can then be used to configure appropriate new security policies, for example when the analysis system is operating in single-step mode.

The security system is also responsible for enforcing security policies to control the behaviour of an application. When assessing the performance of existing security policies, the system administrator can use the analysis system to obtain performance information on what policies are evaluated during the execution of an application and what decisions are being enforced, for example when the analysis system is operating in policy-debugging or logging mode.

The profilers of the analysis system can use the Security Decision data structure of the security system to collect this profile and/or performance information from the monitoring entities and pass it on to the analysis GUI of the analyser system.

Referring to FIG. 21, an overview of the different data structures that are found in a Security Decision data structure 930 is shown for this embodiment. In this embodiment, the Security Decision data structure 930 contains the following fields:
Policy 1 to n: a set of pointers to the Policy data structure 932. Each Policy represents a policy configuration deployed on the device;
Conflict Resolution Mode: because multiple policies could be enforced for any given system call, the security system has to select the decision of one policy (identified as Winning Policy). To do so, a conflict resolution mechanism needs is specified. This field provides information about which conflict resolution mechanism is in place when the decision is taken; and
Winning Policy ID: the ID of the policy that the conflict resolution mechanism has selected among the one deployed in the device.

In this embodiment, the Policy data structure 932 contains information about a specific policy configuration:
Policy ID: the ID of the policy;
Default Outcome: this is the decision taken by default when no rule applies. This can be one of the following outcomes: e.g. allow, ask, deny, and kill;
Priority: this field provides an order on the priority of each outcome. This is because within a policy there might be several rules that apply to the same system call. The outcome with the highest priority will be selected;
Rule 1 to n: a set of pointers to the Rule data structure 934; and
Winning Rule ID: the ID of the rule which outcome is selected for this system call.

In this embodiment, the Rule data structure 934 contains the following fields:
Rule ID: the ID of the rule;
Target: the resource that this rule is controlling access to;
Outcome: the outcome of the rule (e.g. either allow, ask, deny, or kill); and
Additional Parameters: optional parameters.

Exchanging Information Between Profilers and Analysis Agent

The profilers 910a,910b collect the system call information, and also information indicative of the enforced security decision if operating in policy-debugging mode, forwarded from the monitoring entities 908a,908b, create the Process Data data structure 920 and send it to the analysis agent 918. In this embodiment, this data communication is achieved over an IPC channel using, for example, the following API: decision notify (ProcessData data). For example, on detection or interception of a system call invocation by the monitoring entity, the profiler populates the Process Data data structure with the data provided by its associated monitoring entity. Following this, the profiler calls the notify API to send the data to the analysis agent. If in the single-step mode, the analysis agent then retrieves a security decision (e.g. from the analysis GUI on the analysis device) and replies with that security decision, which is then passed by the profiler back to the monitoring entity for enforcement. The operation of the analysis agent depends on what mode it is operating in.

When the analysis system is not active, i.e. the target device is not in data communication with the analysis device or the analysis GUI has not been initiated, the security system on the target device works as previously described in the first and second embodiments based on configured security policies, with the monitoring entities enforcing security decisions determined by the PEP and PDP modules. When the analysis system is active, a signal or instruction is sent to the monitoring entities via the analysis agent to re-configure or instruct the monitoring entities to forward detected system call invocation information, and security decisions enforced if operating in policy-debugging mode), to their respective profilers. This also means that the operation of the monitoring entities is modified such that the security actions or decisions enforced by the monitoring entities are controlled by the analysis system, at least when in single-step mode. In either mode, the system administrator can view information indicative of the application execution, e.g. system call invocations, and any configured security policies being enforced, in real-time for profiling and/or performance analysis.

If the analysis system is operating in logging or policy-debugging mode to assess the performance of configured security policies, the monitoring entities are configured to enforce the configured security policies as they would normally using the PEP and PDP modules. However, additionally, the analysis agent forwards the collected information on the intercepted system call invocation and generated security decision from the profilers to the analysis GUI on the analysis device for review and analysis by a system administrator for example, such that they can assess the performance of the configured security policies.

Alternatively, if the analysis system is operating in single-step mode for profiling applications and configuring new security policies, the monitoring entities are configured to defer to the analysis agent for a security decision to enforce. The security decision returned by the analysis agent to the monitoring entity, via its respective profiler, is the decision (e.g. security action such as allow, ask, deny, and kill) specified by the system administrator operating the analysis GUI. For example, the system call information, representing the system call invocation being initiated by the application executing on the target device, is sent to the analysis GUI of the analysis device by the analysis agent of the target device over the data communication link. The system administrator is then presented with the received information, and can then select a security action such as, but not limited to, allow, ask, deny or kill. The selected decision is then returned by the analysis GUI to the analysis agent on the target device, which forwards it to the relevant profiler. The profiler then forwards the decision to its associated monitoring entity for enforcement. Additionally, the selected security decision made by the system administrator is stored in a policy file or files. As the applications continue to execute, this process continues, and the system administrator progressively builds a customised security policy or policies for the target device. These customised policies can then be deployed or pushed to the target device for enforcement by the security system during normal device operation, or a group of one or more similar target devices in a particular user group controlled by the system administrator.

Pulling Information From the Analysis Agent to the Analysis GUI

In this embodiment, the analysis GUI collects the described information from the analysis agent due to the way in which the port forwarding in ADB works. In some configurations, the analysis agent may be operable to provide buffering. In particular, the analysis agent may provide a buffer to capture data generated after the profilers start to notify the agent of intercepted system call invocations but before the analysis GUI requests the information.

In this embodiment, the analysis GUI on the analysis device 902 and analysis agent on the target device 900 exchange information over the data communication link 904 using the following APIs:
response start(mode)—this command tells the analysis agent to start collecting information from the profilers. The parameter mode represents the selected way in which the analysis system is working (either logging mode or single-step mode). The response is either success or fail. If success, then the analysis agent starts collecting information.
void stop( )—this command stops the analysis agent from collecting further information.
getCalllnfo( )—this command allows the analysis GUI to request system call information from the analysis agent. The analysis agent buffers the information after the start command is sent. Then when the analysis GUI makes this call, the information buffered by the analysis agent until that instance is pushed to the anlaysis GUI over the data communication link.
decision(tag, userDecision)—using this command the analysis GUI informs the analysis agent about the decision the user has selected on a given system call when operating in single-step mode. The analysis agent uses the tag to identify which system call the decision is for.
flush( )—this command tells the analysis agent to flush out all the data stored in the buffer.
getPolicies( )—this command allows the analysis GUI to get the policy configuration installed on the target device. This command returns a file descriptor where the file configuration is stored (e.g. /data/.securitysystem/rules.json)
ps( )—this command allows the analysis GUI to get a list of the processes running on the target device (program name and PID).

Applications of Analysis System

As described above, the analysis system may be operated in various modes, depending on the objectives of user, e.g. system administrator or user associated with the target device. For example, the system can be used for any one or more of the following:
To perform analysis of applications runtime behaviour (access to resources and other applications),
As a profiler to extract information from process executions,
As an analysis system for malicious/suspicious code, and/or
As an educational aid in security courses to demonstrate students how malware behaves.

Advantages of Analysis System

Some embodiments of the analysis system provide the following benefits and/or advantages over existing debuggers or systems:
The analysis system does not require support from specialised kernel level modules such as the Audit system in Linux. The security system collects all the required information transparently to analysis system. This also means that the analysis system may be implemented on other operating systems, such as iOS and Windows, or on any other operating system platform that the security system can be deployed.
The analysis system can work on devices where specialised kernel level modules such as Audit are not enabled or present by default. For example, the version of the kernel present in Android devices is usually a stripped-down version of the kernel distribution for desktops. This means that kernel modules such the Audit are not present by default. The analysis system described does not require support from such modules, so can operate on such Android devices.
Compared to debuggers, the analysis system provides some advantages. First, debuggers rely on libraries to be compiled with special flags enabled to be able to collect meaning information (such as parameters of the system calls). The libraries deployed on the devices by default have the debug symbols disabled for performance reasons. To enable the debug symbols the user has to recompile the libraries with compilation special flags and redeploy them in the device. Second, debuggers often rely on tools such as ptrace that introduces high penalties because of the context switches required between user and kernel space. At least some embodiments of the analysis system do not require the compilation of libraries with special flags or the use of tools such as ptrace.

### 8. General

Embodiments of the analysis system may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the present disclosure. Additional elements or components may also be added without departing from the scope of the present disclosure. Additionally, the features described herein may be implemented in software, hardware, or combination thereof.

In its various aspects, the various embodiments herein may be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the present subject matter includes various forms thereof. Modifications may be made thereto without departing from the scope of this disclosure.

1. An analysis system for analysing applications executing on a target device, the system comprising:
an analysis agent operating on the target device that is configured to receive or retrieve information indicative of system call invocations initiated by applications during execution; and
an analysis device in data communication with the target device over a data communication link that is configured to receive the information from the analysis agent of the target device over the data communication link, and wherein the analysis device comprises an analysis graphical user interface (GUI) that is configured to display the received information for viewing and/or interaction by a user.

2. The analysis system according to claim 1 wherein the target device further comprises a monitoring entity associated with each executing application, wherein each monitoring entity is configured to detect, directly or indirectly, system call invocations made by the associated executing application.

3. The analysis system according to claim 2 wherein each monitoring entity is configured to detect system calls by intercepting the system calls to a kernel of an operating system of the target device.

4. The analysis system according to claim 2 wherein each monitoring entity is configured to detect system calls by intercepting shared or dynamic library symbol invocations that are intended to invoke one or more system calls to the kernel of an operating system of the target device.

5. The analysis system according to claim 2 wherein each monitoring entity forwards, directly or indirectly, system call invocations to the analysis agent of the target device.

6. The analysis system according to claim 5 wherein each monitoring entity comprises an associated profiler that is configured to retrieve or receive information indicative of the system call invocations detected by its associated monitoring entity and forwarding that information to the analysis agent.

7. The analysis system according to claim 6 wherein the profilers of the target device are configured to send or receive information to or from the analysis agent over an Inter Process Communication channel (IPC).

8. The analysis system according to claim 6 wherein each monitoring entity is configured to stall or pause execution of its associated application on detection of a system call invocation, and await a security decision for enforcement, the security decision being an instruction on how to handle the execution of the detected system call invocation.

9. The analysis system according to claim 8 wherein the security decision is any one of the following: allow the system call to execute, deny the system call from executing, modifying the system call, or kill the application execution.

10. The analysis system according to claim 8 wherein the analysis agent of the target device is configured to forward the information indicative of the detected system call invocation(s) to the analysis device and a security decision is generated for the analysis agent based on user input into the GUI of the analysis device, the generated security decision being sent back to the analysis agent which is configured to forward the decision to the relevant monitoring entity, via its respective profiler, for enforcement.

11. The analysis system according to claim 10 wherein the security decisions made on the analysis device are stored in a security policy file.

12. The analysis system according to claim 6 wherein the monitoring entities are components of a security system in which the monitoring entities enforce security decisions in response to detected system call invocations based on a security policy or policies accessible by the security system.

13. The analysis system according to claim 12 wherein each monitoring entity is configured to retrieve and enforce the security decision for a detected system call invocation based on the security policy or policies of the security system, and then forward information indicative of the detected system call invocation and enforced security decisions to the analysis agent via its respective profiler, wherein the analysis agent is configured to forward the information to the analysis device for analysis by a user via the GUI of the analysis device.

14. The analysis system according to claim 6 wherein the analysis agent of the target device is configured to store information received from the profilers in a buffer prior to sending it to the analysis device.

15. The analysis system according to claim 14 wherein the analysis agent of the target device streams or sends the stored buffered information to the analysis device upon receiving a request instruction from the analysis device over the data communication link.

16. The analysis system according to claim 1 wherein the analysis agent of the target device is configured to commence receiving or retrieving information indicative of system call invocations made by applications executing on the target device in response to receiving a start instruction from the analysis device over the data communication link.

17. The analysis system according to claim 1 wherein the analysis agent of the target device is configured to cease receiving or retrieving information indicative of the system call invocations in response to receiving a stop instruction from the analysis device over the data communication link.

18. The analysis system according to claim 1 wherein the target device is a programmable device with an operating system capable of executing applications, and the analysis device is a programmable device with an associated display for the analysis GUI and user input device or devices.

19. The analysis system according to claim 1 wherein the target device comprises a Linux-based kernel and a system architecture defined by a Linux layer associated with the kernel and the higher application layer comprising applications.

20. The analysis system according to claim 1 wherein the target device comprises architecture comprising a kernel space and user space, wherein the kernel space comprises a Unix-like kernel and the user space comprises the applications.

21. A method of analysing applications executing on a target device via an analysis graphical user interface (GUI) displayed on an analysis device in data communication with the target device over a data communication link, comprising:
sending a request instruction over the data communication link to an analysis agent of the target device to request information indicative of the system call invocations initiated by the applications during execution;
receiving at the analysis device the requested information from the analysis agent over the data communication link; and
displaying the requested information to a user on the analysis GUI.

22. A method according to claim 21 wherein the method further comprises generating a start instruction for the analysis agent on the target device to initiate the analysis agent to receive or retrieve information indicative of detected system call invocations initiated by applications during execution.

23. A method according to claim 22 wherein the start instruction is a command generated and sent to the analysis agent over the data communication link.

24. A method according to claim 21 wherein the method further comprises generating a security decision for a detected system call invocation in response to user input, and sending the generated security decision to the analysis agent of the target device over data communication link for enforcing against the detected system call invocation.

25. A method according to claim 24 wherein the method further comprises storing each generated security decision in a security policy file or files to generate a customized security policy or policies for the target device.

26. A method according to claim 21 where in the method further comprises requesting information indicative of the security decisions enforced by a security system operating on the target device in response to detected system call invocations.

27. A method of analysing applications executing on a target device for an analysis graphical user interface (GUI) displayed on an analysis device in data communication with the target device over a data communication link, comprising:
receiving or retrieving at the target device, directly or indirectly, information indicative of detected system call invocations initiated by applications during execution from monitoring entities associated with each executing application;
receiving at the target device a request instruction over the data communication link from the analysis device for the information indicative of the system call invocations initiated by the applications during execution; and
sending the requested information to the analysis device over the data communication link.

28. A method according to claim 27 wherein the method further comprises receiving or retrieving information indicative of system call invocations initiated by applications during execution in response to receiving a start instruction.

29. A method according to claim 27 further comprising halting operation of an application on detection of a system call invocation and awaiting a security decision on how to handle the execution of the detected system call invocation.

30. A method according to claim 29 comprising receiving the security decision from the analysis device over the data communication link, and sending the received security decision to the monitoring entity associated with the halted application to which the security decision relates for enforcement.

31. A method according to claim 29 wherein the method comprises generating the security decision based on a security policy or policies linked to the application, and sending the generated security decision to the monitoring entity associated with the halted application to which the security decision relates for enforcement.

32. A method according to claim 31 wherein the method further comprises sending information indicative of the generated security decisions for detected system call invocations to the analysis device over the data communication link together with the information indicative of the detected system call invocations.
